(19) United States
(12) Patent Application Publication
(10) Pub. No.: US 2024/0030466 A1
(43) Pub. Date: Jan. 25, 2024

(54) BIPOLAR PLATE ASSEMBLIES FOR FUEL CELL STACKS

(71) Applicant: TVS MOTOR COMPANY LIMITED, Chennai (IN)

(72) Inventors: Devaki Krishnan, Chennai (IN); Kompella Venkata Naga Satya Harika, Chennai (IN); Pramila Rao Nileshwar, Chennai (IN); Jabez Dhinagar Samraj, Chennai (IN)

(73) Assignee: TVS MOTOR COMPANY LIMITED, Chennai (CN)

(21) Appl. No.: 18/023,099

(22) PCT Filed: Sep. 1, 2021
(86) PCT No.: PCT/IB2021/057974

§ 371 Date: Feb. 24, 2023

(30) Foreign Application Priority Data
Sep. 1, 2020 (IN) 202041037739

(51) Int. Cl. H01M 8/026; H01M 8/04664; H01M 8/0297; H01M 8/0267; H01M 8/0206

(52) U.S. Cl. CPC H01M 8/026; H01M 8/04679; H01M 8/0297; H01M 8/0267; H01M 8/0206

(57) ABSTRACT

The bipolar plate assembly includes a cathode flow field plate and an anode flow field plate. The cathode flow field plate has a first plurality of flow channels defined between the first plurality of ribs acting as pathway for oxidant, a second plurality of flow channels defined a second plurality of ribs acting as pathway for coolant. The anode flow field plate has a third plurality of flow channels defined between a third plurality of ribs acting as pathway for fuel, and a fourth plurality of flow channels defined between a fourth plurality of ribs acting as pathway for coolant. A first inlet manifold receives the oxidant, the coolant or both, and a second inlet manifold receives the fuel.

### FIELD OF INVENTION

The present subject matter is related to, in general, fuel cell stacks and, in particular, bipolar plate assemblies for fuel cell stacks.

### BACKGROUND

Fuel cell stacks include a plurality of fuel cells, where chemical reactions may occur between a fuel and an oxidant. The chemical reactions may convert the chemical energy of the fuel and the oxidant into electrical energy. The chemical reactions occur at an anode and a cathode of each fuel cell. The fuel cell stacks include bipolar plate assemblies for providing fuel and oxidant to the fuel cells. The bipolar plate assemblies may include cathode flow channels on one side and anode flow channels on an opposite side. The bipolar plate assembly may be positioned between two adjacent cells, where the cathode flow channels may provide oxidant to a cathode of one fuel cell and the anode flow channels may provide fuel to an anode of adjacent fuel cell. Accordingly, the bipolar plate assemblies may separate two adjacent fuel cells.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1a illustrates a perspective view of a fuel cell stack, in accordance with an implementation of the present subject matter;

FIG. 1b illustrates a side view of a fuel cell stack, in accordance with an implementation of the present subject matter;

FIG. 2 illustrates an exploded view of a fuel cell stack, in accordance with an implementation of the present subject matter;

FIG. 3 illustrates an exploded view of a first fuel cell and bipolar plate assemblies, in accordance with an implementation of the present subject matter.

FIG. 4 illustrates an exploded view of a bipolar plate assembly, in accordance with an implementation of the present subject matter;

FIG. 5a illustrates a perspective view of a bipolar plate assembly, in accordance with an implementation of the present subject matter;

FIG. 5b illustrates a sectional view of the bipolar plate assembly taken along the section A-A in the FIG. 5a, in accordance with an implementation of the present subject matter;

FIG. 6a illustrates a perspective view of an anode flow field plate of a bipolar plate assembly, in accordance with an implementation of the present subject matter;

FIG. 6b illustrates an enlarged view of portions of the view depicted in FIG. 6a, in accordance with an implementation of the present subject matter;

FIG. 6c illustrates a rear view of an anode flow field plate of a bipolar plate assembly, in accordance with an implementation of the present subject matter;

FIG. 7 illustrates an anode flow field plate of a bipolar plate assembly, in accordance with an implementation of the present subject matter;

FIG. 8 illustrates a rear view of an anode flow field plate of a bipolar plate assembly, in accordance with an implementation of the present subject matter;

FIG. 9 illustrates an anode flow field plate of a bipolar plate assembly, in accordance with an implementation of the present subject matter;

FIG. 10 illustrates an anode gasket of a bipolar plate assembly, in accordance with an implementation of the present subject matter;

FIG. 11 illustrates a cathode flow field plate of a bipolar plate assembly, in accordance with an implementation of the present subject matter;

FIG. 12 illustrates a perspective view of a cathode flow field plate of a bipolar plate assembly, in accordance with an implementation of the present subject matter;

FIG. 13 illustrates a cathode gasket of a bipolar plate assembly, in accordance with an implementation of the present subject matter;

FIG. 14 illustrates a Membrane Electrode Assembly (MEA) of a fuel cell stack, in accordance with an implementation of the present subject matter;

FIG. 15 illustrates a first current collector plate of a fuel cell stack, in accordance with an implementation of the present subject matter;

FIG. 16 illustrates an inlet end plate of a fuel cell stack, in accordance with an implementation of the present subject matter;

FIG. 17a illustrates a fuel cell system, in accordance with an implementation of the present subject matter;

FIG. 17b illustrates an exploded view of a fuel cell system, in accordance with an implementation of the present subject matter;

FIG. 18 illustrates a fuel cell stack, in accordance with an implementation of the present subject matter;

FIG. 19 illustrates a fuel cell stack, in accordance with an implementation of the present subject matter;

FIG. 20 illustrates an exploded view of a fuel cell stack, in accordance with an implementation of the present subject matter;

FIG. 21 illustrates an exploded view of a bipolar plate assembly disposed between a first fuel cell and a second fuel cell, in accordance with an implementation of the present subject matter;

FIG. 22 illustrates a perspective view of an anode flow field plate of a bipolar plate assembly, in accordance with an implementation of the present subject matter;

FIG. 23 illustrates an enlarged view of a portion of the view depicted in FIG. 22, in accordance with an implementation of the present subject matter;

FIG. 24 illustrates an anode flow field plate of a bipolar plate assembly, in accordance with an implementation of the present subject matter;

FIG. 25 illustrates an MEA of a fuel cell stack, in accordance with an implementation of the present subject matter;

FIG. 26a illustrates a front view of a first current collector plate of a fuel cell stack, in accordance with an implementation of the present subject matter;

FIG. 26b illustrates a rear view of a first current collector plate of a fuel cell stack, in accordance with an implementation of the present subject matter;

FIG. 27a illustrates a front view of an inlet end plate of a fuel cell stack, in accordance with an implementation of the present subject matter;

FIG. 27b illustrates a sectional view of an inlet end plate of a fuel cell stack, in accordance with an implementation of the present subject matter;

FIG. 28a illustrates a front view of an outlet end plate of a fuel cell stack, in accordance with an implementation of the present subject matter;

FIG. 28b illustrates a sectional view of an outlet end plate of a fuel cell stack, in accordance with an implementation of the present subject matter;

FIG. 29 illustrates a recirculation unit of a fuel cell stack, in accordance with an implementation of the present subject matter; and

FIG. 30 illustrates a method to manufacture a bipolar plate assembly, in accordance with an implementation of the present subject matter.

### DETAILED DESCRIPTION

A fuel cell stack may include bipolar plate assemblies positioned between adjacent fuel cells of the fuel cell stack. The bipolar plate assemblies may have cathode flow channels on one side to provide oxidant to one fuel cell and anode flow channels on an opposite side to provide fuel to an adjacent fuel cell.

In some applications of fuel cell stacks, such as in transportation applications, the bipolar plate assemblies are made of graphite due to its high corrosion resistance, high chemical stability, and high thermal conductivity. However, the bipolar plate assemblies made of graphite are to be of a relatively large thickness, as graphite exhibits better mechanical properties only with high thickness. The increase in thickness may increase the size and weight of the fuel cell stack. Further, it is difficult to assemble the components of the fuel cell stack due to increased size and weight.

The fuel cells have to be maintained at a particular temperature range to ensure a satisfactory performance. However, the chemical reactions occurring in each fuel cell releases heat, which increases the temperature of the fuel cells. To maintain the temperature of the fuel cells, a coolant flow field plate may be provided in the fuel cell stack adjacent to some fuel cells. The coolant flow field plate includes flow channels to circulate the coolant. However, the provision of the coolant flow field plates increases the weight of the fuel cell stack. Further, as the number of fuel cells increases, the number of coolant flow field plates also increases. This may result in increased size of fuel cell stack. Further, the arrangement of coolant flow field plate adjacent to some fuel cells results in cooling of some fuel cells and leaving some fuel cells without cooling. This non-uniform cooling across the fuel cell stack reduces performance of the fuel cell stack.

In some scenarios, air may be used as both coolant and the oxidant and a common manifold is provided for the oxidant as well as the coolant. Accordingly, the coolant and the oxidant may have to be provided into the fuel cell stack with the same flow rate. In some scenarios, the oxidant and the coolant may have to be provided at different flow rates in the fuel cell stack. In particular, when the temperature of the fuel cell increases, the coolant flow rate may have to be increased to reduce the temperature of the fuel cell without increasing the flow rate of the oxidant. Having the common manifold for both the oxidant and the coolant may prevent provision of oxidant and coolant at different flow rates, which may reduce the performance of the fuel cell stack. To prevent the impact on the performance of the fuel cells due to the common manifold, manifolds for the coolant and the manifolds for the oxidant are provided separately. However, in such cases, separate ducts for the oxidant and the coolant are to be used. The use of separate ducts for the oxidant and the coolant increases the cost of manufacturing and maintenance of the fuel cells.

The present subject matter relates to bipolar plate assemblies for fuel cell stacks. With the implementations of the present subject matter, the weight of the bipolar plate assemblies and the weight of the fuel cell stack may be reduced. Further, the use of separate coolant flow field plate may be eliminated. Furthermore, uniform cooling may be produced across the fuel cell stack, thereby increasing the performance of the fuel cell.

In accordance with an example implementation, a bipolar plate assembly for a fuel cell stack includes a cathode flow field plate and an anode flow field plate. The cathode flow field plate may include a first cathode surface and a second cathode surface. The second cathode surface may be opposite the first cathode surface. The first cathode surface may have a first plurality of ribs. A flow channel may be defined between two adjacent ribs. The flow channel acts as a pathway for the oxidant for a first fuel cell of the fuel cell stack. The flow channels on the first cathode surface may be referred to as the first plurality of flow channels. The oxidant may be, for example, air. The second cathode surface may have a second plurality of ribs. A flow channel may be defined between two adjacent ribs. The flow channel acts as a pathway for the coolant. The flow channels on the second cathode surface may be referred to as the second plurality of flow channels. The coolant may be, for example, air.

The second plurality of flow channels may be complementary to the first plurality of ribs and the second plurality of ribs may be complementary to the first plurality of flow channels. For instance, formation of a rib on the first cathode surface causes formation of a flow channel on the second cathode surface. Similarly, formation of a flow channel on the first cathode surface causes formation of a rib on the second cathode surface.

Similar to the cathode flow field plate, the anode flow field plate may include a first anode surface and a second anode surface. The second anode surface may be opposite to the first anode surface. The first anode surface may have a third plurality of ribs. A flow channel may be defined between two adjacent ribs. The flow channels act as a pathway for the fuel for a second fuel cell of the fuel cell stack. The flow channels on the first anode surface may be referred to as third plurality of flow channels. The fuel may be, for example, hydrogen. The second anode surface may have a fourth plurality of ribs. The flow channels on the second anode surface acts as a pathway for the coolant. The flow channels on the second anode surface may be referred to as fourth plurality of flow channels. The fourth plurality of flow channels may be complementary to the third plurality of ribs and the fourth plurality of ribs may be complementary to the third plurality of flow channels. That is, formation of a rib on the first anode surface causes formation of a flow channel on the second anode surface. The formation of a flow channel on the first anode surface causes formation of a rib on the second anode surface. The cathode flow field plate and the anode flow field plate may be coupled together, such that the second cathode surface may face and may be in contact with the second anode surface. In an example, the cathode flow field plate and the anode flow field plate may be coupled together by laser welding.

In an example, the flow field plates may be made of metal. To obtain a given mechanical strength of the flow field plates, the metallic flow field plates may have a relatively smaller thickness than the graphite flow field plates. The low thickness of the metallic flow field plates may facilitate the complimentary structure of flow channels and the ribs.

The bipolar plate assembly may further include a first inlet manifold and a second inlet manifold. The first inlet manifold may receive the oxidant, the coolant or both from a first source. In an example, the first inlet manifold may receive both the oxidant and the coolant from a source, such as a blower. The second inlet manifold may receive the fuel from a second source.

The present subject matter eliminates the use of separate coolant flow field plate by having coolant flow channels on the cathode flow field plate and on the anode flow field plate. Therefore, the size of the fuel cell stack is reduced. Further, by having such an arrangement of the coolant flow channels, the present subject matter ensures uniform cooling across the fuel cell stack. Therefore, the present subject matter enhances the performance of the fuel cells. Also, since the thickness of the bipolar plate assembly is less, the present subject matter reduces the weight of the fuel cell stack and facilitates easy assembly of the components of the fuel cell stack. With the implementation of the present subject matter, a common manifold can be used for oxidant and the coolant. Accordingly, the present subject matter prevents use of additional components, such as separate ducts for oxidant and coolant respectively, and reduces the cost of manufacturing of the fuel cell stack.

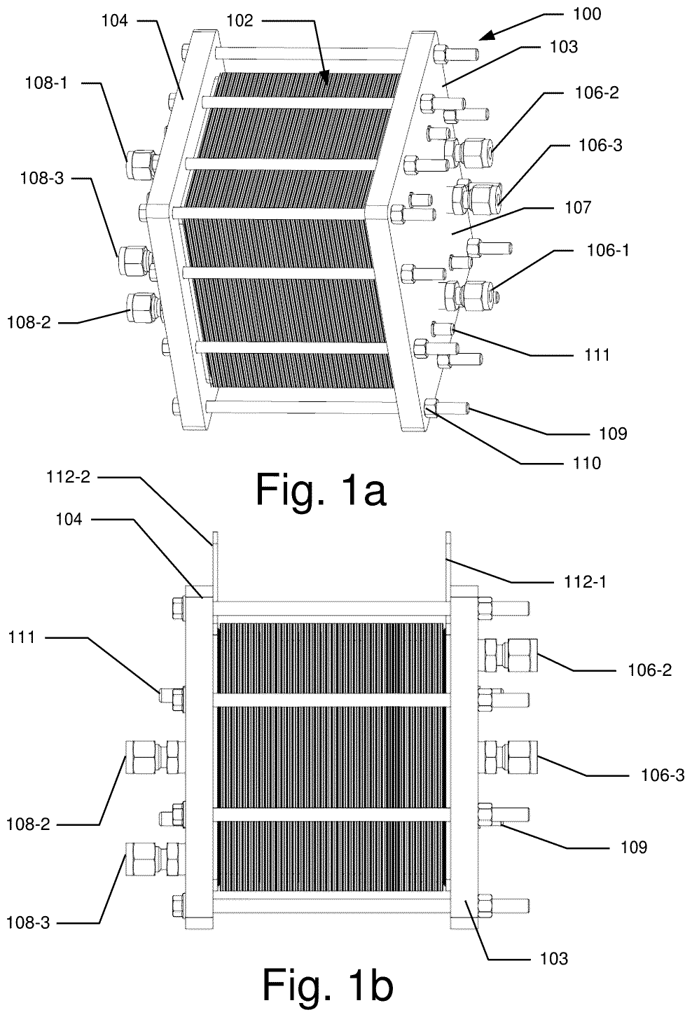

The present subject matter is further described with reference to FIGS. 1a-30. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1a illustrates a perspective view of a fuel cell stack 100, in accordance with an implementation of the present subject matter. The fuel cell stack 100 may include a plurality of fuel cells 102. The fuel cell stack 100 may be, for example, a low temperature polymer electrolyte membrane fuel cell stack (LTPEMFC stack) or a high temperature polymer electrolyte membrane fuel cell stack (HTPEMFC stack). In each fuel cell, chemical reactions may occur between a fuel and an oxidant. The chemical reactions may convert the chemical energy of the fuel and the oxidant into electrical energy. Accordingly, the fuel and the oxidant may be supplied to each fuel cell. The fuel may be, for example, hydrogen. The oxidant may be, for example, air. Further, the temperature of the fuel cell stack 100 may have to be maintained within a temperature range for a satisfactory performance of the fuel cell stack 100. The performance of the fuel cell stack 100 may be measured by the electrical energy produced by the fuel cell stack 100 for a given amount of the fuel and the oxidant. To provide optimum performance, the LTPEMFC stack may have to be maintained at a temperature range of to 80° C. and the HTPEMFC stack may have to be maintained at the temperature range of 80° C. to 160° C. However, the chemical reactions occurring in each fuel cell may increase the temperature of the fuel cell. To maintain the temperature of the fuel cell stack 100, the coolant is circulated in the fuel cell stack. The coolant may be, for example, air.

The fuel cell stack 100 may include an inlet end plate 103 positioned at a first end of the fuel cell stack 100 and an outlet end plate 104 positioned at another end of the fuel cell stack 100. The fuel cells 102 may be positioned between the inlet end plate 103 and the outlet end plate 104. The inlet end plate 103 may facilitate entry of the fuel, the oxidant, and the coolant into the fuel cell stack 100. Accordingly, the inlet end plate 103 may include a first inlet 106-1 through which the fuel is provided to the fuel cell stack 100, a second inlet 106-2 and a third inlet 106-3 through which the oxidant and the coolant are provided to the fuel cell stack 100. Further, the first inlet 106-1 may be displaced in a direction perpendicular from the second inlet 106-2 relative to a centre of the inlet end plate 107 and from the third inlet 106-3 relative to the centre of the inlet end plate 107. The outlet end plate 104 may facilitate removal of the fuel, the oxidant, and the coolant. Accordingly, the outlet end plate 104 may include the first outlet 108-1 through which the excess fuel is removed from the fuel cell stack 100, the second outlet 108-2 and the third outlet 108-3 through which excess oxidant and coolant are removed from the fuel cell stack 100. The position of the outlets on the outlet end plate 104 may be similar to the position of the inlets on the inlet end plate 103. That is, the second outlet 108-2 and the third outlet 108-3 may be positioned adjacent to each other. Further, the first outlet 108-1 may be displaced from the second outlet 108-2 and from the third outlet 108-3 in a perpendicular direction relative to a centre (not shown in FIG. 1a) of the outlet end plate 104.

The fuel cell stack 100 may further include tie-rods 109 and bolts 110 to assemble the components of the fuel cell stack 100. In an example, the fuel cell stack 100 may include guiders 111, which may facilitate assembly of the components of the fuel cell stack 100 together.

FIG. 1b illustrates a side view of the fuel cell stack 100, in accordance with an implementation of the present subject matter. The fuel cell stack 100 may include a plurality of current collector plates, which may collect current from each fuel cell. For instance, the fuel cell stack 100 may include a first current collector plate 112-1 and a second current collector plate 112-2. The first current collector plate 112-1 may be disposed adjacent to the inlet end plate 103 and the second current collector plate 112-2 may be disposed adjacent to the outlet end plate 104. In an example, components, such as wires, may be connected between the first current collector plate 112-1 and the second current collector plate 112-2 to extract electrical energy from the fuel cell stack 100.

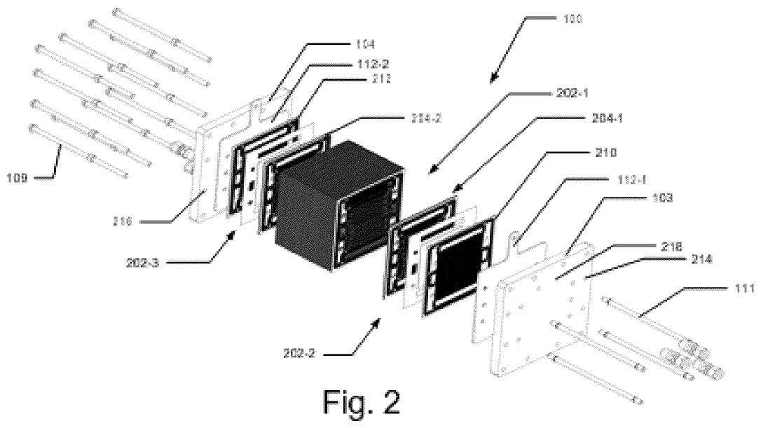

FIG. 2 illustrates an exploded view of the fuel cell stack 100, in accordance with an implementation of the present subject matter. The plurality of fuel cells 102 include fuel cells, such as a first fuel cell 202-1, a second fuel cell 202-2, and a third fuel cell 202-3. The fuel cell 202-2 is disposed at one end of the fuel cell stack 100 and the fuel cell 202-3 is disposed at an opposite end of the fuel cell stack 100. To provide the fuel and the oxidant to each fuel cell, the fuel cell stack 100 may include a plurality of bipolar plate assemblies, such as 204-1, 204-2, 204-3, to provide oxidant or the fuel to the fuel cells. For instance, the bipolar plate assembly 204-1 may provide oxidant for the first fuel cell 202-1 and fuel for the second fuel cell 202-2. Accordingly, the bipolar plate assembly 204-1 may be positioned between two adjacent fuel cells, i.e., between the first fuel cell 202-1 and the second fuel cell 202-2. The bipolar plate assemblies 204-1, 204-2, 204-3 may be referred to as the bipolar plate assembly 204. Each bipolar plate assembly 204 may have a cathode flow field plate (not shown in FIG. 2) to provide oxidant to one fuel cell and an anode flow field plate (not shown in FIG. 2) to provide fuel to another fuel cell.

In an example, the fuel cells 202-2, 202-3 at the ends of the fuel cell stack 100 may have to be provided either with the fuel or with the oxidant, since the fuel cells 202-2, 202-3 are provided with the oxidant or the fuel by the adjacent bipolar plate. For instance, the fuel cell 202-3 is provided with the oxidant by the bipolar plate assembly 204-2 and may have to be provided with the fuel for the chemical reaction to occur at the fuel cell 202-3. Similarly, the second fuel cell 202-2 is provided with the fuel by the bipolar plate assembly 204-1 and may have to be provided with the oxidant for chemical reaction to occur at the second fuel cell 202-2. Accordingly, to provide either of the fuel or the oxidant to the fuel cells 202-2, 202-3 at the ends of the fuel cell stack 100, the fuel cell stack 100 may include monopolar flow field plates, such as monopolar cathode flow field plate 210 and monopolar anode flow field plate 212. For instance, the monopolar cathode flow field plate 210 may be disposed between the first current collector plate 112-1 and the second fuel cell 202-2 and may provide oxidant to the second fuel cell 202-2. The monopolar anode flow field plate 212 may be disposed between the second current collector plate 112-2 and the third fuel cell 202-3 and may provide fuel to the third fuel cell 202-3.

In an example, the monopolar flow field plates and part of bipolar plate assemblies may form a part of the fuel cell. For instance, the monopolar cathode flow field plate 210 and the anode flow field plate of the bipolar plate assembly 204-1 may form the part of the second fuel cell 202-2. Similarly, the monopolar anode flow field plate 212 and the cathode flow field plate of the bipolar plate assembly 204-2 may form a part of the fuel cell 202-3.

As mentioned earlier, the fuel cell stack 100 may include the tie-rods 109 and the guiders 111 to facilitate fastening of the components of the fuel cell stack 100. The tie-rods 109 may hold the components of the fuel cell stack 100 together and may extend from the inlet end plate 103 to the outlet end plate 104 without passing through the bipolar plate assemblies of the fuel cell stack 100. Accordingly, to facilitate insertion of the tie-rods 109, the inlet end plate 103 may include provisions, such as openings 214 and the outlet end plate 104 may include provisions, such as opening 216 to facilitate insertion of tie-rods 109. A tie-rod may extend between an opening on the inlet end plate 103 and a corresponding opening on the outlet end plate 104 and may be fastened with a bolt. In an example, the dimensions of the inlet end plate 103 and the outlet end plate 104 may be higher than the dimensions of the bipolar plate assemblies, the fuel cells 102, the current collector plate 112-1, 112-2, and the monopolar flow field plates 210,212. As will be understood, the dimensions of the bipolar plate assemblies, the fuel cells, and the monopolar flow field plates 210, 212 may be substantially similar. The openings through which the tie-rods 109 pass through on the inlet end plate 103 and the outlet end plate 104 may be provided on a portion of the end plates 103, 104 that does not contact with the monopolar flow field plate 210, 212 to ensure that the tie-rods 109 do not pass through the monopolar flow field plates 210, 212, the current collector plates 112-1, 112-2, the bipolar plate assemblies, and the fuel cells. Further, the inlet end plate 103 may include guider holes 218 and the outlet end plate 104 may include guider holes (not shown in FIG. 2) to facilitate insertion of guiders 111. A guider may extend from a guider hole on the inlet end plate 103, pass through the components of the fuel cell stack 100 and extend to a corresponding guider hole on the outlet end plate 104. The guiders 111 are to align the bipolar plate assemblies and the MEA during assembly. As will be understood, some fuel cells in the fuel cell stack 100 may receive fuel from one bipolar plate assembly and the oxidant from an adjacent bipolar plate assembly.

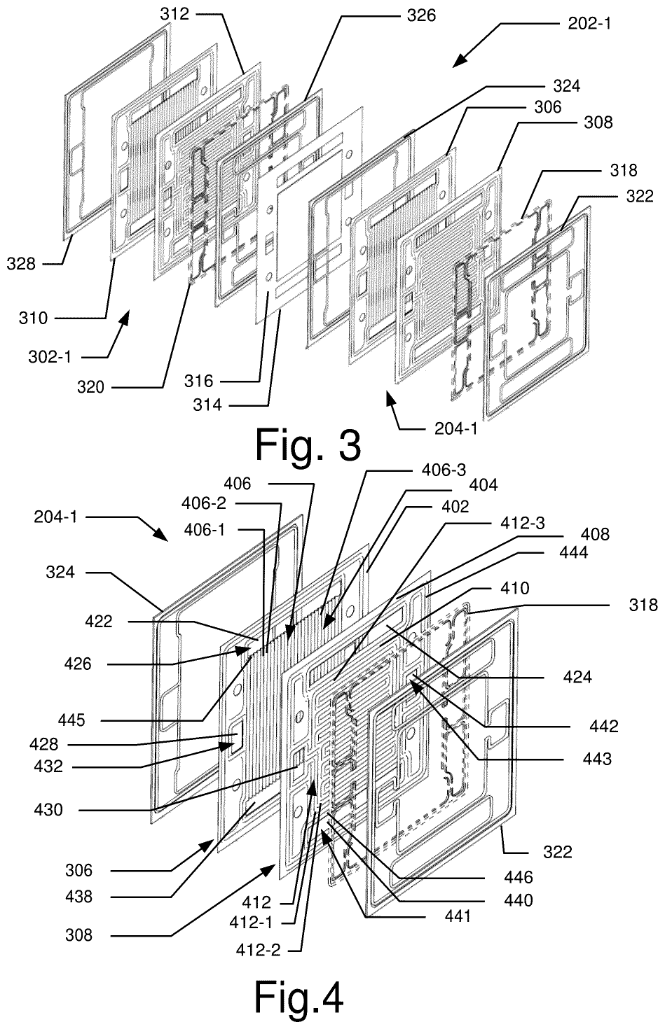

FIG. 3 illustrates an exploded view of the first fuel cell 202-1 and bipolar plate assemblies 204-1, 302-1, in accordance with an implementation of the present subject matter. Here, the first fuel cell 202-1 is positioned between a bipolar plate assembly 302-1 and the bipolar plate assembly 204-1. The bipolar plate assembly 204-1 may provide the oxidant to the first fuel cell 202-1 and the bipolar plate assembly 302-1 may provide fuel to the first fuel cell 202-1.

As mentioned earlier, the bipolar plate assemblies 204 may include a cathode flow field plate and an anode flow field plate. For instance, a cathode flow field plate 306 and an anode flow field plate 308 may be part of the bipolar plate assembly 204-1, a cathode flow field plate 310 and an anode flow field plate 312 may be part of the bipolar plate assembly 302-1. The cathode flow field plate and the anode flow field plate may face each other and contact each other.

The anode flow field plate 308 may face the second fuel cell 202-2 (not shown in FIG. 3) and may provide fuel to the second fuel cell 202-2. The cathode flow field plate 306 may face the first fuel cell 202-1 and may provide the oxidant to the first fuel cell 202-1. The anode flow field plate 312 may face the first fuel cell 202-1 to provide the fuel to the first fuel cell 202-1 and the cathode flow field plate 310 may face another fuel cell (not shown in FIG. 3) to provide oxidant to that fuel cell.

As will be understood, a part of the bipolar plate assembly 204-1 and a part of the bipolar plate assembly 302-1 may form a part of the first fuel cell 202-1. That is, the anode flow field plate 312 and the cathode flow field plate 306 may be a part of the first fuel cell 202-1. The first fuel cell 202-1 may include a membrane electrode assembly 314, where the chemical reactions between the fuel and the oxidant occurs. The MEA 314 may include a cathode 316 on a first side and an anode on a side opposite to the first side. In the depicted view herein, the anode may be behind the cathode 316. The cathode 316 may receive the oxidant from the cathode flow field plate 306 and the anode may receive the fuel from the anode flow field plate 312. Accordingly, the anode may face the bipolar plate assembly 302-1 and the cathode 316 may face the bipolar plate assembly 204-1. Further, the MEA 314 may include a polymer electrolyte membrane (PEM) (not shown in FIG. 3) positioned between the cathode 316 and the anode. The MEA 314 may also include a plurality of gas diffusion layers (not shown in FIG. 3). A gas diffusion layer may be positioned between the cathode flow field plate 306 and the cathode 316, and a gas diffusion layer may be positioned between the anode flow field plate 312 and the anode. The gas diffusion layers may diffuse the reactant gases, such as the fuel and the oxidant, across the anode and the cathode 316 respectively to facilitate chemical reaction across the surface of the cathode 316 and across the surface of the anode.

During operation, at the anode, hydrogen provided by an anode flow field plate 312 may be split into hydrogen ions and electrons. The hydrogens ions may be allowed to pass through the PEM and reach the cathode 316. On the other hand, the electrons may not be allowed through the PEM. The electrons from the anode of each fuel cell may reach the first current collector plate 112-1 (not shown in FIG. 3). From the first current collector plate 112-1, these electrons may flow through an external circuit to the second current collector plate 112-2 (not shown in FIG. 3). This supplies electrical power to the external circuit. From the second current collector plate 112-2, the electrons may reach the cathode of each fuel cell. At the cathode 316, the hydrogen ions, the electrons, and the oxygen from the oxidant may react to form water and release heat energy.

In an example, the cathode flow field plate 306 and the anode flow field plate 308 may be welded together. The welding may be performed, for instance, on the anode flow field plate. Here, a weld seam 318 may be on top of the anode flow field plate 308 and a weld seam 320 may be on top of the anode flow field plate 312.

Further, the bipolar plate assembly 204-1 may include a gasket (referred to as anode gasket) 322 on the anode flow field plate 308 to prevent leakage of the fuel and a gasket 324 (referred to as cathode gasket) on the cathode flow field plate 306 to prevent leakage of the oxidant. Similarly, the bipolar plate assembly 302-1 may include an anode gasket 326 on the anode flow field plate 312 and a cathode gasket 328 on the cathode flow field plate 310.

The bipolar plate assembly may be explained with reference to the bipolar plate assembly 204-1. However, it will be understood that the bipolar plate assembly may be explained with reference to other bipolar plate assembly of the fuel cell stack 100.

FIG. 4 illustrates an exploded view of the bipolar plate assembly 204-1, in accordance with an implementation of the present subject matter. The cathode flow field plate 306 may include a first cathode surface (not shown in FIG. 4) and a second cathode surface 402. The second cathode surface 402 may be opposite the first cathode surface. The first cathode surface may have a first plurality of ribs (not shown in FIG. 4). A flow channel (not shown in FIG. 4) may be defined between two adjacent ribs to act as a pathway for the oxidant for the first fuel cell 202-1. The flow channels on the first cathode surface may be referred to as the first plurality of flow channels. The second cathode surface 402 may have a second plurality of ribs 404. A flow channel may be defined between two adjacent ribs to act as a pathway for the coolant. The flow channels, such as flow channel 406-1, 406-2, and 406-3 on the second cathode surface 402 may be collectively referred to as the second plurality of flow channels 406. The formation of a rib on the first cathode surface causes formation of a flow channel on the second cathode surface 402. The formation of a flow channel on the first cathode surface causes formation of a rib on the second cathode surface 402. Accordingly, the second plurality of flow channels 406 may be complementary to the first plurality of ribs and the second plurality of ribs 404 may be complementary to the first plurality of flow channels.

The anode flow field plate 308 may include a first anode surface 408 and a second anode surface (not shown in FIG. 4). The second anode surface may be opposite the first anode surface 408. The first anode surface 408 may have a third plurality of ribs 410. A flow channel may be defined between two adjacent ribs. The flow channel, such as 412-1, 412-2, and 412-3, on the first anode surface 408 may be referred to as a third plurality of flow channels 412. The third plurality of flow channels 412 may act as a pathway for the fuel for the second fuel cell 202-2. The second anode surface may have a fourth plurality of ribs (not shown in FIG. 4). A flow channel may be defined between two adjacent ribs to act as a pathway for the coolant. The flow channels on the second anode surface may be referred to as the fourth plurality of flow channels (not shown in FIG. 4). In an example, the first plurality of flow channels and the second plurality of flow channels 406 may be in a direction perpendicular to the third plurality of flow channels 412 and to the fourth plurality of flow channels.

The formation of a rib on the first anode surface 408 causes formation of a flow channel on the second anode surface. The formation of a flow channel on the first anode surface 408 causes formation of a rib on the second anode surface. Accordingly, the fourth plurality of flow channels may be complementary to the third plurality of ribs 410 and the fourth plurality of ribs may be complementary to the third plurality of flow channels 412.

As mentioned earlier, the cathode flow field plate 306 and the anode flow field plate 308 may face each other and may contact each other. In particular, the second cathode surface 402 may face and may be in contact with the second anode surface.

To obtain a given mechanical strength of the flow field plates, each flow field plate may have a small thickness. For instance, a metal sheet with a thickness range of 50 micron to 100 micron may be stamped to form the flow field plate with a thickness of 0.3 mm to 1 mm. In an example, each flow field plate may have a thickness of 0.8 mm. Therefore, each bipolar plate assembly 204, having a cathode flow field plate and an anode flow field plate, may have a thickness of 1.6 mm. The flow field plates made of metal with small thickness may possess properties, such as high mechanical strength, high electrical conductivity, high thermal conductivity, and high gas impermeability with small thickness. The small thickness of the metallic flow field plates may facilitate the complimentary structure of flow channels and the ribs. That is, the formation of a flow channel on one surface of a flow field plate due to formation of a rib on another surface of the flow field plate is achieved by using a flow field plate of low thickness. Accordingly, in an example, the cathode flow field plate 306 and the anode flow field plate 308 may be made of metal.

Further, in each fuel cell, to prevent the increase in temperature of the fuel cell due to chemical reactions, a coolant may have to be circulated through the fuel cell stack. In the present subject matter, the bipolar plate assembly may facilitate flow of coolant through the second plurality of flow channels 406 and through the fourth plurality of flow channels. Therefore, the present subject matter reduces the size and weight of the fuel cell stack 100 when compared to the scenarios where the fuel cell stacks use separate coolant plates for facilitating flow of coolant through the fuel cell stack.

Further, when the cathode flow field plate 306 and the anode flow field plate 308 are assembled, a first opening 422 of the cathode flow field plate 306 and a second opening 424 of the anode flow field plate 308 form a first inlet manifold 426. The first inlet manifold 426 may receive the oxidant, the coolant, or both from a first source (not shown in FIG. 4) such as a blower, through the second inlet 106-2 (not shown in FIG. 4) and the third inlet 106-3 (not shown in FIG. 4). Accordingly, to provide the oxidant and the coolant, the first inlet manifold 426 may be coupled to the first plurality of flow channels, to the second plurality of flow channels 406, and to the fourth plurality of flow channels.

Further, when the cathode flow field plate 306 and the anode flow field plate 308 are assembled, a third opening 428 of the cathode flow field plate 306 and a fourth opening 430 of the anode flow field plate 308 may together form a second inlet manifold 432. The second inlet manifold 432 may receive the fuel from a second source. For instance, the second inlet manifold 432 may receive the fuel from a fuel source through the first inlet 106-1 (not shown in FIG. 4). Accordingly, to provide the fuel, the second inlet manifold 432 may be coupled to the third plurality of flow channels 412. In particular, the fourth opening 430 may be coupled to the inlet of the third plurality of flow channels 412.

The first inlet manifold 426 and the second inlet manifold 432 may be disposed perpendicular to each other when viewed from the centre of the bipolar plate assembly 204-1. For instance, the first opening 422 may be displaced from the second opening 424 on the cathode flow field plate 306 relative to a centre (not shown in FIG. 4) of the cathode flow field plate 306, and the second opening 424 may be displaced from the fourth opening 430 on the anode flow field plate 308 relative to a centre of the anode flow field plate 308. The disposition of the first inlet manifold 426 perpendicular to the second inlet manifold 432 may prevent the mixing of the fuel and the oxidant.

The oxidant and the coolant entering the fuel cell stack 100 through the second inlet 106-2 and the third inlet 106-3, may reach each fuel cell via the first inlet manifold 426 in the bipolar plate assembly 204-1 to be supplied to the fuel cell 202-1 (not shown in FIG. 4). The fuel entering the fuel cell stack 100 through the first inlet 106-1 may reach each bipolar plate assembly 204-1 through the second inlet manifold 432 to be supplied to the fuel cell 202-1 (not shown in FIG. 4).

Further, in an assembled state, i.e., when the cathode flow field plate 306 and the anode flow field plate 308 are assembled together, a fifth opening 438 of the cathode flow field plate 306 and a sixth opening 440 of the anode flow field plate 308 may together form a first outlet manifold 441. Similarly, a seventh opening (not shown in FIG. 4) of the cathode flow field plate 306 and an eighth opening 442 of the anode flow field plate 308 may together form a second outlet manifold 443. The first outlet manifold 441 may remove the oxidant and the coolant from the bipolar plate assembly 204-1. The second outlet manifold 443 may remove the excess fuel from the bipolar plate assembly 204-1.

The cathode flow field plate 306 and the anode flow field plate 308 may be coupled together by welding on the first anode surface 408. The welding may be, for example, continuous welding performed on the first anode surface 408. The continuous welding performed on the first anode surface 408 may prevent leakage, which may be caused due to increase of pressure in the fuel cell stack 100. The welding may be performed on a first anode groove 444 on the first anode surface 408. As a result of the welding, the weld seam 318 may be formed on the top of the first anode groove 444. The anode gasket 322 may be positioned on top of the weld seam 318 to prevent the leakage of the fuel. For instance, a liquid sealant may be poured on top of the weld seam and allowed to solidify to form the anode gasket 322 on the first anode surface 408. Similar to the anode flow field plate 308, the cathode flow field plate 306 may include a first cathode groove (not shown in FIG. 4). The cathode gasket 324 may be positioned on the first cathode groove to prevent the leakage of the oxidant. To ensure that the welding of the bipolar plate assembly 204-1 is intact, continuous welding may be performed adjacent to the edges of the anode flow field plate 308, and around the second inlet manifold 432 and the second outlet manifold 443. Further, to facilitate the coolant entry into and the removal from the second plurality of flow channels 406 and the fourth plurality of flow channels, the welding may be performed around the first inlet manifold 426 and the first outlet manifold 441. In particular, the continuous welding may be performed around three sides of the first inlet manifold 426 and around three sides of the first outlet manifold 441 respectively. Further, the welding may not be performed on a fourth side 445 of the first inlet manifold and on a fourth side 446 of the first outlet manifold 441. The welding may prevent the leakage of coolant from the second anode surface and the second cathode surface 402. Accordingly, the welding may prevent the usage of the gasket between the anode flow field plate and the cathode flow field plate. The provision of the welding points around three sides of the first inlet manifold 426 and not providing the welding points around the fourth side creates a gap between the second anode surface and the second cathode surface 402. The gap between second anode surface and the second cathode surface 402 streamlines the coolant flow.

In an example, instead of performing welding on the anode flow field plate 308, the welding may be done on the cathode flow field plate 306. For instance, the welding may be done on the first cathode groove. This causes formation of a weld seam (not shown in FIG. 4) on the first cathode groove. In such an example, the cathode gasket 324 may be disposed on top of the weld seam. For instance, a liquid sealant may be poured on top of the weld seam and allowed to solidify to form the cathode gasket 324 on the first cathode surface. In such an example, the anode gasket 322 may be disposed on top of the first anode groove 444. In the present subject matter, a single groove (i.e., either the first anode groove 444 or the first cathode groove) may be used for both welding and sealing purposes. Accordingly, the present subject matter may increase the flow field area for the fuel and the oxidant and simplifies manufacturability of the bipolar plate assemblies.

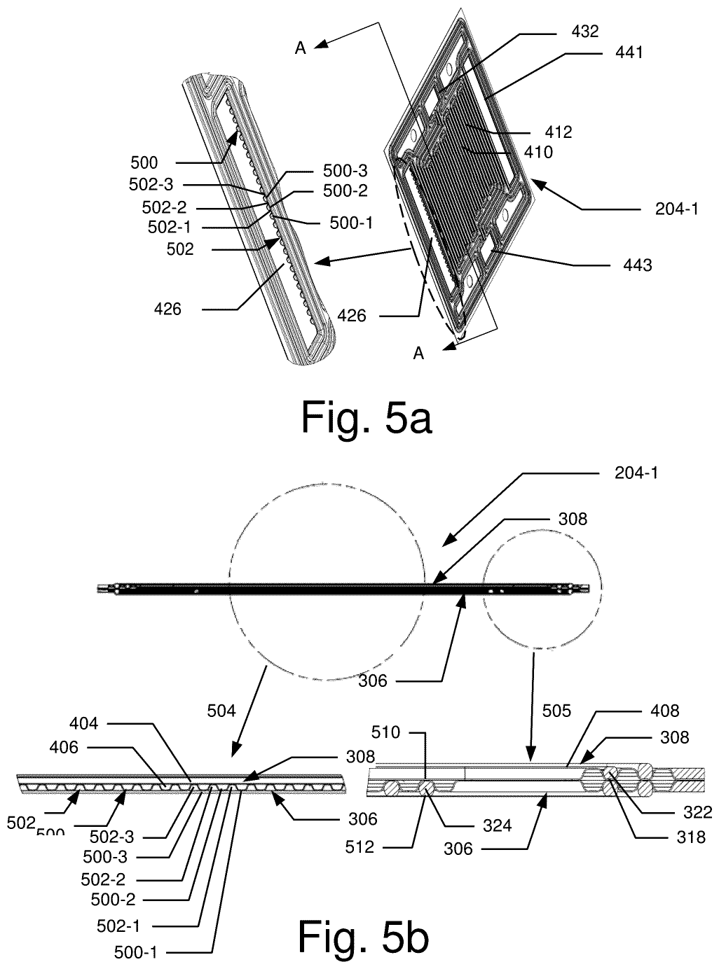

FIG. 5a illustrates a perspective view of the bipolar plate assembly 204-1 of the fuel cell stack 100, in accordance with an implementation of the present subject matter. The first cathode surface may include the first plurality of ribs 500-1, 500-2, 500-3 and the first plurality of flow channels 502-1, 502-2, 502-3. The plurality of ribs, 500-1, 500-2, 500-3 may be collectively referred to as the first plurality of ribs 500. The first plurality of flow channels 502-1, 502-2, 502-3 may be collectively referred to as the first plurality of flow channels 502. The first plurality of flow channels 502 may act as a pathway for the oxidant for the fuel cell 202-1 (not shown in FIG. 5). Further, through the first inlet manifold 426, the oxidant may enter the first plurality of flow channels 502. Accordingly, an inlet of the first plurality of flow channels 502 may be coupled to the first inlet manifold 426. Further through the first outlet manifold 441, the excess oxidant may exit the bipolar plate assembly 204-1. Accordingly, an outlet of the first plurality of flow channel 502 may be coupled to the first outlet manifold 441. Through the second inlet manifold 432, the fuel may enter the third plurality of flow channels 412. Accordingly, an inlet of the third plurality of flow channels 412 may be coupled to the second inlet manifold 432. Further through the second outlet manifold 443, the excess fuel may exit the bipolar plate assembly 204-1. Accordingly, an outlet of the third plurality of flow channels 412 may be coupled to the second outlet manifold 443. In particular, the eighth opening 442 may be coupled to the outlet of the third plurality of flow channels 412 to facilitate removal of excess fuel from the bipolar plate assembly 204-1.

FIG. 5b illustrates a sectional view of the bipolar plate assembly 204-1 taken along the section A-A in the FIG. 5a, in accordance with an implementation of the present subject matter. In the view depicted herein, the anode flow field plate 308 lies above the cathode flow field plate 306. Here, enlarged views 504, 505 of depict a portion of the sectional view.

In the enlarged view 504, the first plurality of ribs 500 is complimentary to the second plurality of flow channels 406 and the first plurality of flow channels 502 is complimentary to the second plurality of ribs 404. The flow channels 502-1, 502-2, 502-3 are depicted in the view herein. As will be understood, in the depicted view herein, the third plurality of flow channels 412 and the fourth plurality of flow channels are not visible, since the sectional view is taken across the section A-A, which is in a direction parallel to the first plurality of flow channels.

As illustrated in the enlarged view 505, the anode gasket 322 is disposed on the weld seam 318 of the first anode surface 408. The anode gasket 322 may prevent leakage of the fuel. Similarly, the cathode gasket 324 may be disposed on top of the first cathode groove 510 of the first cathode surface 512. The cathode gasket 324 may prevent leakage of the oxidant.

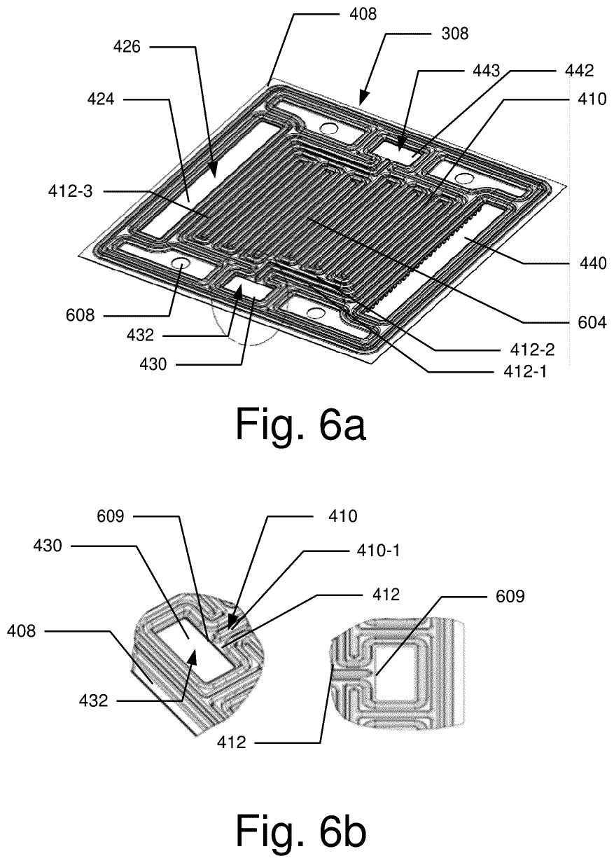

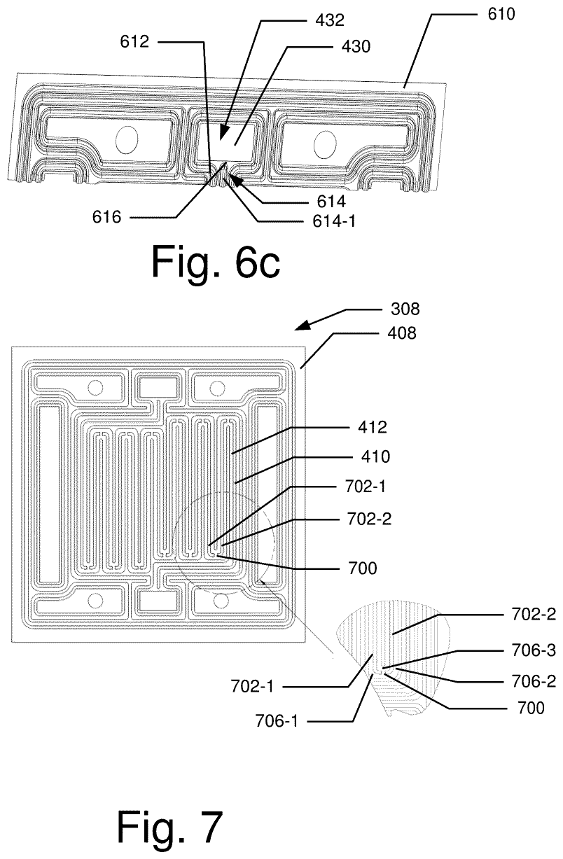

FIG. 6a illustrates a perspective view of the anode flow field plate 308 of the bipolar plate assembly 204-1, in accordance with an implementation of the present subject matter. The third plurality of ribs 410 may be of a serpentine pattern. Accordingly, the third plurality of flow channels 412 may be of serpentine pattern. Further, since the fourth plurality of ribs (not shown in FIG. 6) and the fourth plurality of flow channels (not shown in FIG. 6) are complementary to the third plurality of flow channels 412 and the third plurality of ribs 410 respectively, the fourth plurality of ribs and the fourth plurality of flow channels may be of serpentine pattern.

The fuel entering the inlet of the third plurality of flow channels 412 through the second inlet manifold 432 may take the serpentine path and may reach the gas diffusion layer positioned adjacent to the anode flow field plate 308. As will be understood, in the view depicted herein, a gas diffusion layer may be disposed on top of the anode flow field plate 308. The fuel, which does not reach the gas diffusion layer, may reach an outlet of the third plurality of flow channels 412 and may exit the bipolar plate assembly 204-1 through the second outlet manifold 443.

Further, the second opening 424 and the fourth opening 430 of the anode flow field plate 308 may be disposed perpendicular to each other when viewed from the centre 604 of the anode flow field plate 308. Similarly, the sixth opening 440 and the eighth opening 442 of the anode flow field plate 308 may be disposed perpendicular to each other when viewed from the centre 604 of the anode flow field plate 308. This may facilitate the fuel manifold and the oxidant manifolds being perpendicular to each other. Therefore, the mixing of the fuel and the oxidant in the bipolar plate assembly 204-1 may be prevented.

The first inlet manifold 426 and the second inlet manifold 432 may be disposed perpendicular to each other when viewed from the centre of the bipolar plate assembly 204-1. As mentioned earlier, the guiders 111 (not shown in FIG. 6a) may facilitate assembling of various components of the fuel cell stack 100. Accordingly, the anode flow field plate 308 may have a plurality of guider holes 608 to facilitate insertion of guiders 111.

FIG. 6b illustrates an enlarged view of portions of the view depicted in FIG. 6a, in accordance with an implementation of the present subject matter. To prevent the flow of the fuel on the second anode surface (not shown in FIG. 6b), a section 609 that is devoid of ribs and flow channels may be formed on the first anode surface 408. The section 609 may be nearer to the fourth opening 430 than to the centre 604 (not shown in FIG. 6b) of the anode flow field plate 308. The section 609 may be referred to as the first flat section. The first flat section 609 may be provided for a pre-determined length near the fourth opening 430. Further, a rib 410-1, which is a part of the third plurality of ribs 410, may extend from the first flat section 609. The positioning of the first flat section 609 and the rib 410-1 may ensure that the fuel that enters the third plurality of flow channels 412 from the fourth opening 430 does not flow on the second anode surface (not shown in FIG. 6b) as will be explained with reference to FIG. 6c.

FIG. 6c illustrates a rear view of the anode flow field plate 308 of the bipolar plate assembly 204-1, in accordance with an implementation of the present subject matter. Here, the second anode surface 610 is depicted. The fourth plurality of ribs 612 may be complementary to the third plurality of flow channels 412 (not shown in FIG. 6c) and the fourth plurality of flow channels 614 may be complementary to the third plurality of ribs 410 (not shown in FIG. 6c). The displacement of the rib 410-1 from the second inlet manifold 432 may displace a channel 614-1 of the fourth plurality of flow channels 614 at a distance from the second inlet manifold 432. The first flat section 609 (not shown in FIG. 6c) has a corresponding section 616 formed on the second anode surface 610. The section 616 may be nearer to the second inlet manifold 432 than the centre 604 (not shown in FIG. 6c) of the anode flow field plate 308. The section 616 may be devoid of ribs and flow channels and may be referred to hereinafter as second flat section. The section 616 may be alternatively referred to as the anode flat section.

Similar to the anode flow field plate 308, the cathode flow field plate 310 (not shown in FIG. 6c) may include a section on the first cathode surface 512. The section on the first cathode surface 512 may be nearer to the third opening 428 than to the centre of the cathode flow field plate 310. The section may be devoid of the ribs and the flow channels and may be referred to as the third flat section. The cathode flow field plate 310 may include a section (not shown in FIG. 6c) on the second cathode surface 402. The section on the second cathode surface 402 may be nearer to the third opening 428 than the centre of the cathode flow field plate 310. Further, the section on the second anode surface 402 may be devoid of the ribs and flow channels and may be referred to as the fourth flat section. The fourth flat section may be alternatively referred to as the cathode flat section. As will be understood, the formation of the third flat section may cause the formation of the fourth flat section. The fourth flat section may be disposed at a position on the cathode flow field plate 310 corresponding to a position of the second flat section 616 on the anode flow field plate 312. Accordingly, the bipolar plate assembly 204-1 may be welded such that the second flat section 616 faces and is in contact with the fourth flat section of the second cathode surface 402. The welding may prevent the fuel from flowing on the second anode surface 610 as it enters from the second inlet manifold 432. That is, the fuel reaching the second inlet manifold 432 may enter the first anode surface 408 and may not reach the second anode surface 610 due to the welding. Therefore, the present subject matter prevents the mixing of the fuel and the coolant.

In some cases, the gas diffusion layer adjacent to the anode flow field plate 308 may be broken due to factors, such as increase in temperature, excess compression during assembling of the components of the fuel cell stacks, and the like. Further, in some cases, the hydrogen fuel may be humidified to maintain the hydration of the MEA to improve the performance of the fuel cell. As a result, water clogging in the third plurality of flow channels 412 may occur. The water clogging may result in blocking the path for hydrogen fuel. Accordingly, in such examples, to prevent blockage of the fuel the anode flow field plate 308, the anode flow field plate 308 may include additional pathway for the fuel, as will be described below.

FIG. 7 illustrates the anode flow field plate 308 of the bipolar plate assembly 204-1, in accordance with an implementation of the present subject matter. To prevent the blockage of the fuel in the anode flow field plate 308, the anode flow field plate may comprise a bypass channel 700 between adjacent ribs of the third plurality of ribs 410. For instance, a first rib 702-1 and a second rib 702-2 may be unconnected and displaced from each other, and the bypass channel 700 may be formed between the first rib 702-1 and the second rib 702-2 at the displaced portion. The bypass channel 700 may act as an additional pathway for the fuel. If one or more flow channels of the third plurality of flow channels 412 are blocked, the fuel may enter the bypass channels 700 to flow to another channel, which may not be blocked. For instance, consider that the fuel is flowing through the flow channel 706-1 and moving towards the flow channel 706-2. Further, consider that the flow channel 706-2 is blocked. The fuel flowing from the flow channel 706-1 may pass through the bypass channel 700 to reach the flow channel 706-3. This may prevent the thwarting of the fuel flow due to the blockage of the flow channel 706-2.

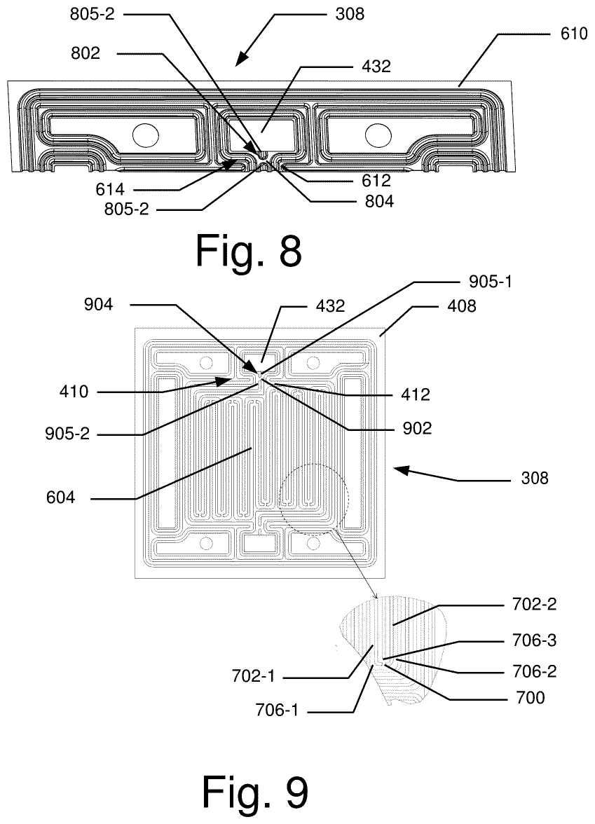

FIG. 8 illustrates a rear view of the anode flow field plate 308 of the bipolar plate assembly 204-1, in accordance with an implementation of the present subject matter. Here, the second anode surface 610 is shown. In an example, a rib on the first anode surface 408 (not shown in FIG. 8) may be disposed adjacent to the second inlet manifold 432 without a flat section between the second inlet manifold 432 and the rib. As will be understood, the rib may be part of the third plurality of ribs 410 (not shown in FIG. 8). The third plurality of flow channels 412 (not shown in FIG. 8) may extend from the second inlet manifold 432. Due to formation of the third plurality of ribs 410 extending from the second inlet manifold 432, the fourth plurality of flow channels 614 may extend from the second inlet manifold 432 on the second anode surface 610. Since the fourth plurality of flow channels 614 extends from the second inlet manifold 432, the fuel reaching the second inlet manifold 432 may enter the fourth plurality of flow channels 614 on the first anode surface 408 (not shown in FIG. 8). As will be understood, the extension of the third plurality of ribs 410 from the second inlet manifold 432 may prevent the entry of the fuel on the second anode surface 610. Therefore, the fuel may flow on the first anode surface 408 and may not flow on the second anode surface 610.

However, in some examples, the fuel may still enter the second anode surface 610. To prevent the flow of the fuel on the second anode surface 610, a rib extending from the second inlet manifold 432 on the first anode surface 408 (not shown in FIG. 8) may be made discontinuous. The rib extending from the second inlet manifold 432 on the first anode surface 408 may be referred to as the third rib. The third rib may have discontinuity nearer to the second inlet manifold 432 than to centre 604 (not shown in FIG. 8) of the anode flow field plate 308. As will be understood, the discontinuity is devoid of the rib and flow channels. The discontinuity may be referred to as the fifth flat section. In some examples, the fifth flat section may also act as additional pathway for the flow of fuel on the first anode surface 408.

Due to the discontinuity of the third rib, a flow channel 802 extending from the second inlet manifold 432 may have a discontinuity 804. The flow channel 802 may be part of the fourth plurality of flow channels 614 and may have discontinuity nearer to the second inlet manifold 432 than to the centre 604 of the anode flow field plate 308. The flow channel 802 may be referred to as the first flow channel. The first flow channel 802 may be complementary to the third rib. The discontinuity 804 in the first flow channel 802 may be devoid of ribs and flow channels and may be referred to as the sixth flat section. The sixth flat section 804 may prevent further flow of the fuel on the second anode surface 610. For instance, the fuel entering the second anode surface 610 through the first flow channel 802 may be blocked by the sixth flat section 804. That is, the fuel that enters a portion 805-1 of the first flow channel 802 may be blocked by the sixth flat section 804 and may not flow to a portion 805-2 of the first flow channel 802. Therefore, the mixing of the fuel and the coolant is prevented.

FIG. 9 illustrates the anode flow field plate 308 of the bipolar plate assembly 204-1, in accordance with an implementation of the present subject matter. In some examples, both the bypass channels 700 and a discontinuous rib extending from the second inlet manifold 432 may be provided. As mentioned earlier, the fifth flat section 902 is formed in the third rib 904 between a portion 905-1 of the third rib 904 and a portion 905-2 of the third rib 904. The formation of the fifth flat section 902 on the first anode surface 408 may form the sixth flat section 804 (not shown in FIG. 9) on the second anode surface 610 (not shown in FIG. 9). Therefore, in such examples, the thwarting of the fuel movement may be prevented due to the bypass channels 700 and the flow of the fuel on the second anode surface 610 (not shown in FIG. 9) may be prevented due to the formation of a discontinuous rib nearer to the second inlet manifold 432 than to the centre 604 of the anode flow field plate 308, as mentioned earlier with reference to FIG. 8.

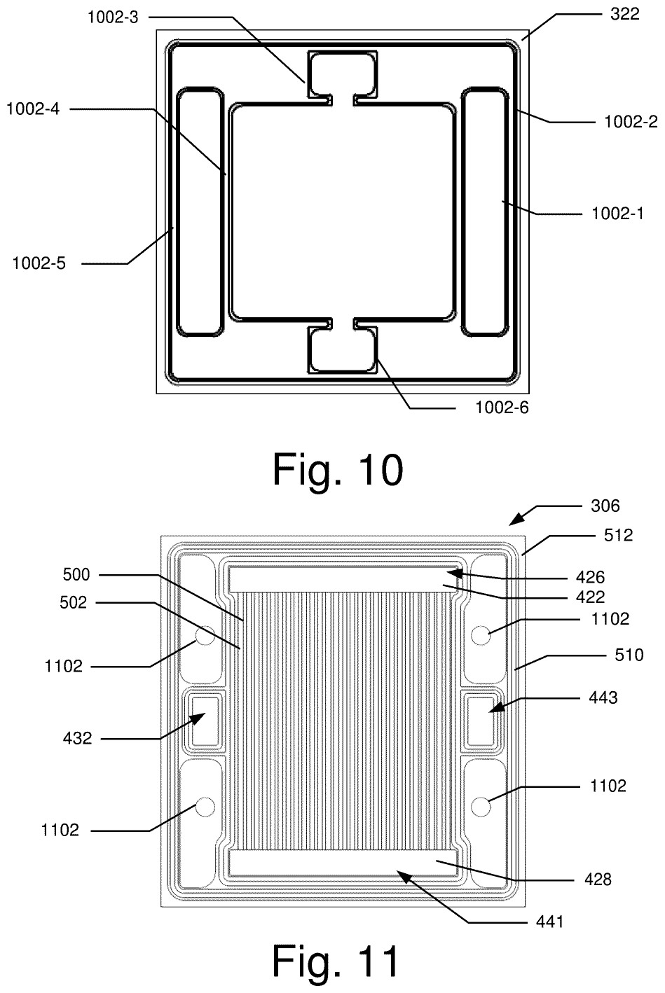

FIG. 10 illustrates the anode gasket 322 of the bipolar plate assembly 204-1, in accordance with an implementation of the present subject matter. In an example, to form the anode gasket 322, the liquid sealant may be dispensed on the weld seam 318 (not shown in FIG. 10) on the first anode surface 408 (not shown in FIG. 10). The solidification of the liquid sealant forms the anode gasket 322. The liquid sealant may be, for example, Acrylated Urethane, RTV Silicone, Loctite 5883 (polyacrylate), Loctite 5910 (Oxime silicone) or any combination thereof. In an example, to prevent the leakage of the fuel, the anode gasket 322 may have different segments, such as 1002-1-1002-6, that surround different portions of the anode flow field plate 308. For instance, the segment 1002-1 surrounds the first inlet manifold 426, the segment 1002-2 extends adjacent to the edges of the anode flow field plate 308, the segment 1002-3 surrounds the second inlet manifold 432, the segment 1002-4 surrounds the third plurality of flow channels 412, the segment 1002-5 surrounds the first outlet manifold 441, and the segment 1002-6 surrounds the second outlet manifold 443.

FIG. 11 illustrates the cathode flow field plate 306 of the bipolar plate assembly 204-1, in accordance with an implementation of the present subject matter. Here the first cathode surface 512 is shown. Here, the second cathode surface 402 is behind the first cathode surface 512.

Each of the first plurality of ribs 500 and each of the first plurality of flow channels 502 may run between the first inlet manifold 426 and the first outlet manifold 441 on the first cathode surface 512. Accordingly, each of the first plurality of ribs 500 and each of the first plurality of flow channels 502 may be parallel to each other. The first inlet manifold 426 may be coupled to an inlet of the first plurality of flow channels 502 such that the oxidant enters the first plurality of flow channels 502. For instance, the first opening 422 of the cathode flow field plate 306 may be coupled to the inlet of the first plurality of flow channels 502.

Further, since the ribs and the flow channels on one surface of the flow field plate are complementary to the flow channels and the ribs on the opposite surface of the flow field plate respectively, the second plurality of ribs 404 (not shown in FIG. 11) and the second plurality of flow channels 406 (not shown in FIG. 11) may also run from the first inlet manifold 426 to the first outlet manifold 441 on the second cathode surface 402 (not shown in FIG. 11). The first inlet manifold 426 may be coupled to the inlet of the second plurality of flow channels 406 on the second cathode surface 402 such that the coolant enters the second plurality of flow channels 406. For instance, the first opening 422 may be coupled to the inlet of the second plurality of flow channels 406.

In an example, each of the second plurality of flow channels 406 may be parallel to each other and the fourth plurality of flow channels 614 may be serpentine. Accordingly, the coolant entering the bipolar plate assembly 204-1 may have both serpentine flow and a parallel flow. This may ensure that the pressure drop inside the bipolar plate assembly 204-1 due to the flow of the coolant may be less. The reduced pressure drop may enhance the performance of the fuel cell.

Similar to the anode flow field plate 308 (not shown in FIG. 11), the cathode flow field plate 306 may also include a plurality of guider holes 1102 to facilitate insertion of the guiders 111 to assembly various components of the fuel cell stack 100.

Here, the first cathode groove 510 is depicted. As mentioned earlier, on top of the first cathode groove 510, the cathode gasket 324 may be disposed. For the purpose of clarity, the cathode gasket 324 is not depicted in this view. In some examples, the welding may be done on cathode flow field plate 306 to form the weld seam. The first inlet manifold 426 is provided with the welding points around it. In such examples, the cathode gasket 324 may be disposed on top of the welding seam.

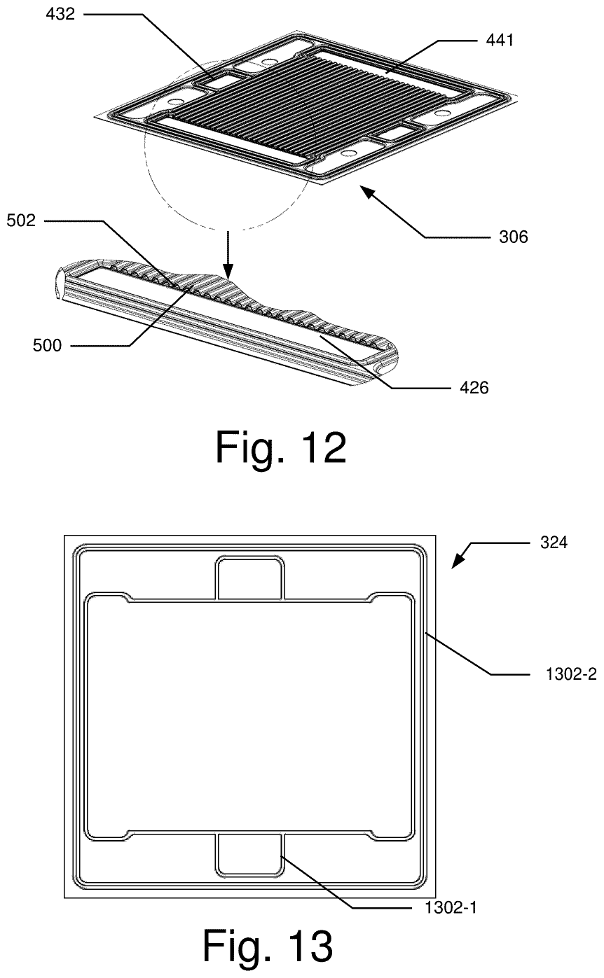

FIG. 12 illustrates a perspective view of the cathode flow field plate 306 of the bipolar plate assembly 204-1, in accordance with an implementation of the present subject matter. The first inlet manifold 426 may provide both oxidant and the coolant to the bipolar plate assembly 204-1. The oxidant and the coolant provided from the single source (not shown in FIG. 12) may enter the first inlet manifold 426. From the first inlet manifold 426, air may enter the first plurality of flow channels 502 and the second plurality of flow channels 406 (not shown in FIG. 12).

FIG. 13 illustrates the cathode gasket 324 of the bipolar plate assembly 204-1, in accordance with an implementation of the present subject matter. In an example, to form the cathode gasket 324, the liquid sealant may be dispensed on top of the first cathode groove 510 (not shown in FIG. 13). The solidification of the liquid sealant forms the cathode gasket 324. The liquid sealant may be, for example, Acrylated Urethane, RTV Silicone, Loctite 5883 (polyacrylate), Loctite 5910 (Oxime silicone) or any combination thereof.

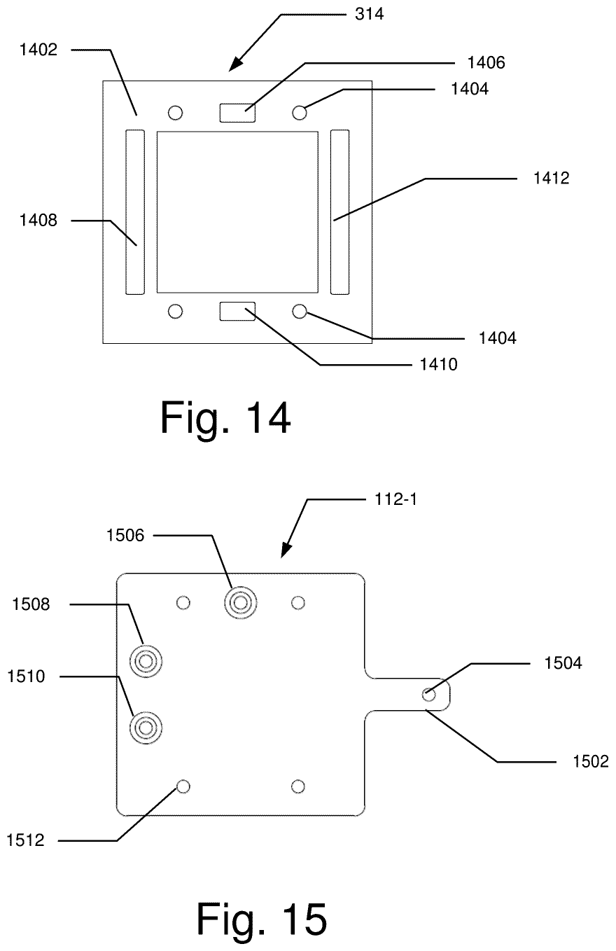

To prevent the leakage of the oxidant, the cathode gasket 324 may have different segments, such as 1302-1 and 1302-2, to surround various components of the cathode flow field plate 306 (not shown in FIG. 12). For instance, the segment 1302-1 surrounds the first plurality of flow channels 502, the first inlet manifold 426, the first outlet manifold 441, the second inlet manifold 432, and the second outlet manifold 443 and the segment 1302-2 may extend adjacent to the edges of the cathode flow field plate 306. FIG. 14 illustrates the MEA 314 of the fuel cell stack 100, in accordance with an implementation of the present subject matter. The MEA 314 may include the anode 1402 and the cathode 316 behind the anode 1402. The PEM may be positioned between the cathode and the anode. The MEA 314 may include a plurality of guider holes 1404 to facilitate insertion of the guiders 111 (not shown in FIG. 14). The MEA 314 may also include the openings, such as an opening 1406 for the inlet of the fuel to pass through to the adjacent bipolar plate assembly 302-1 (not shown in FIG. 14), an opening 1408 for the oxidant and the coolant to pass through to the adjacent bipolar plate assembly 302-1. Similarly, the openings 1410, 1412 facilitate exit of the fuel and the oxidant that is removed from the adjacent bipolar plate assembly 302-1 (not shown in FIG. 14) from the fuel cell stack 100.

FIG. 15 illustrates the first current collector plate 112-1 of the fuel cell stack 100, in accordance with an implementation of the present subject matter. As mentioned earlier, the electrons flowing from anode of each bipolar plate may reach the first current collector plate 112-1 and may flow from the first current collector plate 112-1 to the second current collector plate 112-2 (not shown in FIG. 15), through the external circuit, such as a wire connected between the first current collector plate 112-1 and the second current collector plate 112-2, which may constitute electrical current through the fuel cell stack 100. In this regard, to conduct flow of electrons, the first current collector plate 112-1 may include a protrusion 1502. The protrusion 1502 may further include an opening 1504 through which the wire may be coupled.

Further, the first current collector plate 112-1 may include openings, such as an opening 1506, for facilitating flow of fuel, an opening 1508, an opening 1510 for facilitating flow of the oxidant and the coolant. Further, the first current collector plate 112-1 may also include guider holes 1512 to facilitate insertion of the guiders 111 (not shown in FIG. 15).

The second current collector plate 112-2 may have a similar arrangement as the first current collector plate 112-1. For instance, the second current collector plate 112-2 may also include a protrusion including an opening. The wire may be connected between the opening 1504 on the first current collector plate 112-1 and the opening on the second current collector plate 112-2. In an assembled state of the fuel cell stack 100, the protrusion of the first current collector plate 112-1 and the second current collector plate 112-2 may extend beyond the other components of the fuel cell stack 100.

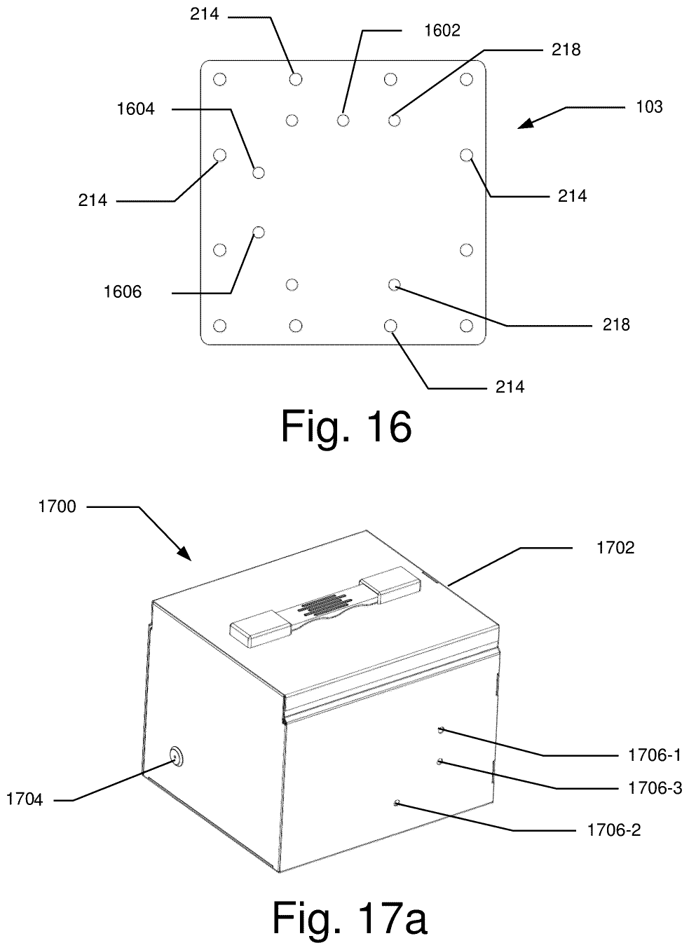

FIG. 16 illustrates the inlet end plate 103 of the fuel cell stack 100, in accordance with an implementation of the present subject matter. The inlet end plate 103 may include openings, such as 1602, for inlet of the fuel and openings 1604, 1606 for the inlet of air, which is used as both oxidant and the coolant. Further, the inlet end plate 103 may also include openings 214 to facilitate insertion of the tie-rods and guider holes 218 to facilitate insertion of the guiders 111 (not shown in FIG. 16). In an example, the dimensions of the inlet end plate 103 may be higher than the other components of the fuel cell stack 100.

Although, in the above example, the end plate is explained with reference to the inlet end plate 103, the end plate may also be explained with reference to the outlet end plate 104. Accordingly, the outlet end plate 104 may include an opening each for the removal of the fuel, for the removal of the oxidant and for the removal of the coolant from the fuel cell stack 100. Further, the outlet end plate 104 may include openings for the tie-rods 109 and guider holes for the guiders 111. In some examples, the fuel cell stack 100 may be enclosed in a casing, as will be explained below.

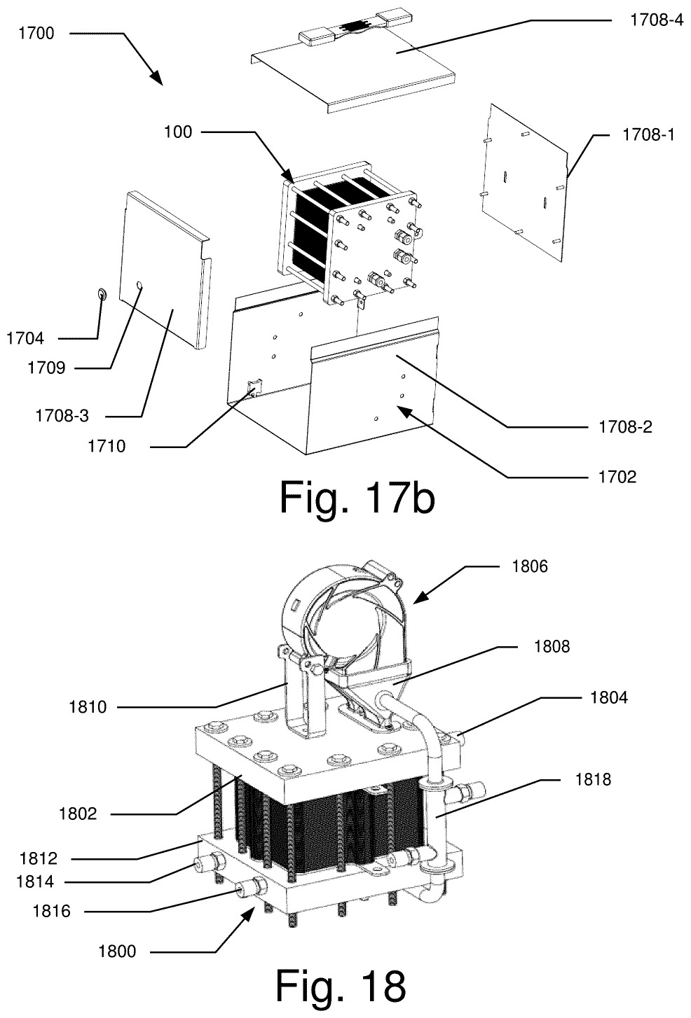

FIG. 17a illustrates a fuel cell system 1700, in accordance with an implementation of the present subject matter. In an example, the fuel cell stack 100 (not shown in FIG. 17a) may be enclosed within a casing 1702 and may be referred to as the fuel cell system 1700. The casing 1702 may be, for example, metal casing. The chemical reactions occurring inside the fuel cell stack 100 may increase the pressure in the casing 1702. If the pressure increases beyond a particular value, the fuel cell system 1700 may explode. To avoid pressure build up in the casing 1702, and to prevent the explosion, the fuel cell system 1700 may include a pressure relief valve 1704 provided in the casing 1702. Further, an opening 1706-1 may facilitate coupling of the fuel source to the first inlet 106-1, openings 1706-2, 1706-3 may facilitate coupling of the air source with the second inlet 106-2, and the third inlet 106-3.

FIG. 17b illustrates an exploded view of the fuel cell system 1700, in accordance with an implementation of the present subject matter. The casing 1702 may include a plurality of segments, such as segments 1708-1, 1708-2, 1708-3, and 1708-4. The segments may be fastened together, for example, using fasteners (not shown in FIG. 17b) to form an enclosure surrounding the fuel cell stack 100. The casing 1702 may include an opening 1709 through which the pressure relief valve 1704 may be coupled to the casing 1702. The fuel cell system 1700 may include a hydrogen sensor 1710 to detect hydrogen leak. The hydrogen sensor 1710 may be provided within the casing 1702.

In some examples, the source for the oxidant and the coolant, such as an air source, may be positioned on top of the fuel cell stack 100, as will be described below.

FIG. 18 illustrates a fuel cell stack 1800, in accordance with an implementation of the present subject matter. In some examples, the source for the oxidant and the coolant may be coupled to top of the fuel cell stack 1800. The fuel cell stack 1800 may be similar to the fuel cell stack 100.

Similar to the fuel cell stack 100, the fuel cell stack 1800 may include an inlet end plate 1802 for facilitating supply of the fuel, the oxidant, and the coolant from their respective sources. The inlet end plate 1802 may include a first inlet (not shown in FIG. 18) and a second inlet 1804. The first inlet may supply both the oxidant and the coolant to the fuel cell stack 1800 from a first source 1806, which may be, for example, a blower. Hereinafter the first source may be explained with reference to the blower. The first inlet may be coupled to the blower 1806. For instance, the first inlet may be coupled to a first duct 1808 of the blower. In an example, the blower 1806 may be supported by the inlet end plate 1802. For instance, the blower 1806 may be coupled to a top surface of the inlet end plate 1802 using a blower bracket 1810. The second inlet 1804 may provide fuel to the fuel cell stack 1800 from a fuel source (not shown in FIG. 18). Accordingly, the second inlet 1804 may be coupled to the fuel source. The fuel cell stack 1800 may further include an outlet end plate 1812. The excess fuel, excess oxidant, and excess coolant from the fuel cell stack 1800 may be removed through the outlet end plate 1812. Accordingly, the outlet end plate 1812 may include a first outlet 1814 and a second outlet 1816. The first outlet 1814 may remove excess hydrogen from the fuel cell stack 1800 and the second outlet 1816 may remove excess air from the fuel cell stack 1800. Further, in an example, the excess air removed from the fuel cell stack 1800 may be recirculated again into the fuel cell stack 1800 through a recirculation unit 1818 of the fuel cell stack 1800.

Although in the above example, a single inlet (the first inlet) is provided for both the oxidant and the coolant. In some examples, separate inlets may be provided for the oxidant and the coolant. Further, in the above example, the oxidant and the coolant may be provided through a single duct (first duct 1808), in some examples, the oxidant and the coolant may be provided from separate ducts from the blower 1806.

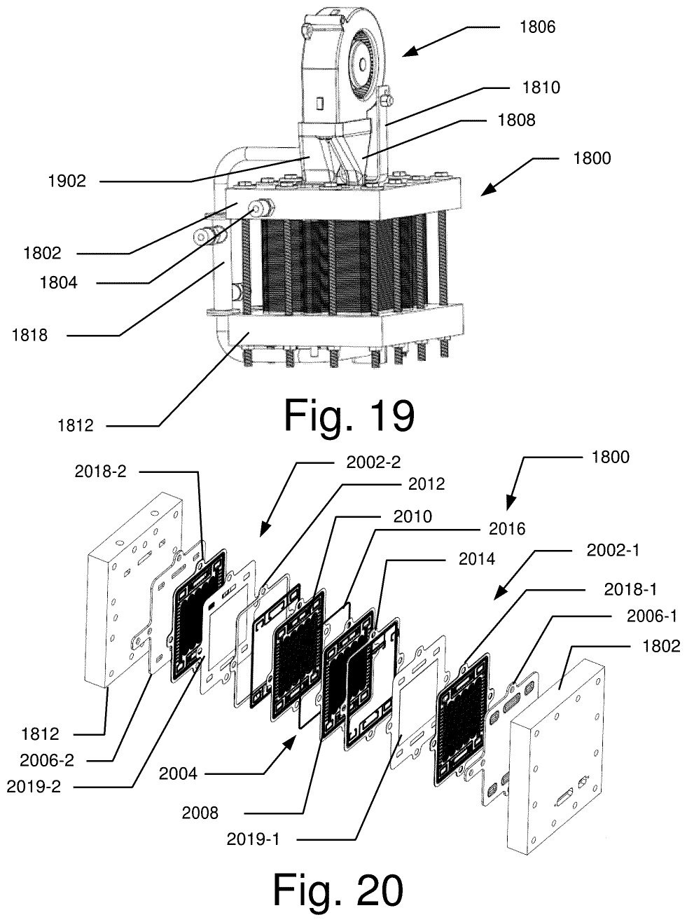

FIG. 19 illustrates the fuel cell stack 1800, in accordance with an implementation of the present subject matter. The blower 1806 may include a second duct 1902. In such an example, the inlet end plate 1802 may include a third inlet (not shown in FIG. 19). The second inlet (not shown in FIG. 19) may provide the oxidant to the fuel cell stack 1800 and the third inlet may provide the coolant to the fuel cell stack 1800. The first duct 1808 may be coupled to the first inlet and the second duct 1902 may be coupled to the third inlet to provide the coolant to the fuel cell stack 1800.

The outlet end plate 1812 includes a third outlet (not shown in FIG. 19). The first outlet may remove the excess oxidant and the third outlet may remove excess coolant from the fuel cell stack. Further, an end of the recirculation unit 1818 may be coupled to the third outlet and another end of the recirculation unit may be coupled to the second duct 1902 to recirculate the air.

FIG. 20 illustrates an exploded view of the fuel cell stack 1800, in accordance with an implementation of the present subject matter. The fuel cell stack 1800 may include a plurality of fuel cells, such as a first fuel cell 2002-1 and a second fuel cell 2002-2. The fuel cell stack 1800 may include a bipolar plate assembly 2004, the first current collector plate 2006-1, and the second current collector plate 2006-2. The first current collector plate 2006-1 may be similar to the first current collector plate 112-1, and the second current collector plate 2006-2 may be similar to the second current collector plate 112-2.

The bipolar plate assembly 2004 may be positioned between the first fuel cell 2002-1 and the second fuel cell 2002-2. The bipolar plate assembly 2004 may provide oxidant to the first fuel cell 2002-1 and may provide fuel to the second fuel cell 2002-2. Accordingly, the bipolar plate assembly 2004 may include a cathode flow field plate 2008, which may provide the oxidant to the first fuel cell 2002-1 and an anode flow field plate 2010, which may provide fuel to the second fuel cell 2002-2. The cathode flow field plate and the anode flow field plate may be, for example, made of metal, such as stainless steel. The cathode flow field plate 2008 and the anode flow field plate 2010 may face each other and may be in contact with each other. The bipolar plate assembly 2004 may include a plurality of gaskets, such as an anode gasket 2012 on the anode flow field plate 2010 to prevent the leakage of the fuel and a cathode gasket 2014 on the cathode flow field plate 2008 to prevent the leakage of the oxidant. Further, in an example, bipolar plate assembly 2004 may include provisions for the flow of the coolant in the bipolar plate assembly 2004. A third gasket 2016 may be disposed between the cathode flow field plate 2008 and the anode gasket 2012 at the portion where the cathode flow field plate 2008 and the anode gasket 2012 that face each other. The third gasket 2016 may prevent the leakage of the coolant. Further, the bipolar plate assembly 2004 may include a cathode edge gasket (not shown in FIG. 20) disposed along the edge of the cathode flow field plate 2008 and an anode edge gasket 2017 disposed along the edge of the anode flow field plate 2010. The edge gaskets may prevent the breaking of the bipolar plate assembly 2004 during the compression of the fuel cell stack 1800.

In an example, at the ends of the fuel cell stack 1800, the flow field plates may have to face fuel cell on only one of its sides and may have to provide fuel or the oxidant to that fuel cell. Accordingly, at the ends of the fuel cell stack 1800, the fuel cell stack 1800 may include monopolar flow field plates, such as a monopolar anode flow field plate 2018-1 and a monopolar cathode flow field plate 2018-2. For instance, the monopolar anode flow field plate 2018-1 may be disposed adjacent to the first current collector plate 2006-1 and may provide fuel to the fuel cell 2002-1. The monopolar cathode flow field plate 2018-2 may be disposed adjacent to the second current collector plate 2006-2 and may provide oxidant to the fuel cell 2002-2.

In an example, the monopolar flow field plates and a part of the bipolar plate assembly 2004 may form a part of each fuel cell. For instance, the cathode flow field plate 2008 of the bipolar plate assembly 2004 and the monopolar anode flow field plate 2018-1 may be a part of the first fuel cell 2002-1. Similarly, the monopolar cathode flow field plate 2018-2 and the anode flow field plate 2010 of the bipolar plate assembly 2004 may form a part of the second fuel cell 2002-2.

Each fuel cell may include an MEA, where the chemical reactions occur converting the chemical energy to mechanical energy. Here, the MEA 2019-1 is a part of the first fuel cell 2002-1 and the MEA 2019-2 is a part of the second fuel cell 2002-2. Each MEA may include an anode, a cathode and a PEM.

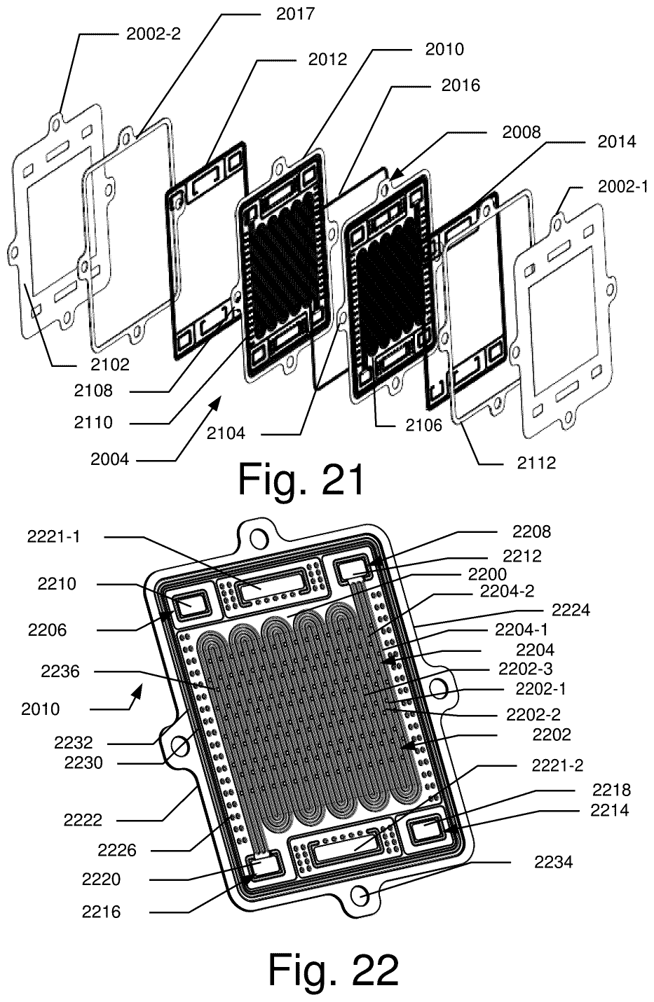

FIG. 21 illustrates an exploded view of the bipolar plate assembly 2004 disposed between the first fuel cell 2002-1 and the second fuel cell 2002-2, in accordance with an implementation of the present subject matter. Each MEA may also include a gas diffusion layer (not shown in FIG. 21) adjacent to the cathode and a gas diffusion layer (not shown in FIG. 12) adjacent to the anode. The gas diffusion layer may spread the fuel or oxidant across the anode or the cathode to have uniform chemical reactions across the cathode and the anode.

The cathode flow field plate 2008 may include a first cathode surface 2104 and a second cathode surface (not shown in FIG. 21). The second cathode surface may be opposite the first cathode surface 2104. The first cathode surface 2104 may include a first plurality of ribs. A flow channel may be defined between two adjacent ribs. The flow channels on the first cathode surface 2104 may be referred to as the first plurality of flow channels 2106. The first plurality of flow channels 2106 may act as a pathway for the oxidant. In an example, the first cathode surface 2104 may face a cathode (not shown in FIG. 21) of the MEA 2019-1 to provide oxidant to the cathode. The second cathode surface may include a second plurality of ribs (not shown in FIG. 21). A flow channel may be defined between two adjacent ribs. The flow channels on the second cathode surface may be referred to as the second plurality of channels. The second plurality of flow channels may act as pathway for the coolant.

The anode flow field plate 2010 may include a first anode surface (not shown in FIG. 21) and a second anode surface 2108. The second anode surface 2108 may be opposite the first anode surface. The first anode surface may include a third plurality of ribs. A flow channel may be defined between two adjacent ribs. The flow channels on the first anode surface may be referred to as the third plurality of channels. The third plurality of flow channels may act as a pathway for the fuel. In an example, first anode surface may face the anode 2102 of the MEA 2019-2 to provide fuel to the anode. The second anode surface 2108 may include a fourth plurality of ribs (not shown in FIG. 21). A flow channel may be defined between two adjacent ribs. The flow channels on the second anode surface 2108 may be referred to as fourth plurality of flow channels 2110. The fourth plurality of flow channels 2110 may act as pathway for the coolant.

The cathode flow field plate 2008 and the anode flow field plate 2010 are made of metals, which are of low thickness, the flow channels on one side may be complimentary to the ribs on the opposite surface. That is, the first plurality of ribs may be complementary to the second plurality of flow channels, the first plurality of flow channels 2106 may be complementary to the second plurality of ribs, the third plurality of ribs may be complementary to the fourth plurality of flow channels 2110, and the third plurality of flow channels may be complementary to the fourth plurality of ribs.

Further, as mentioned earlier, the anode edge gasket 2017 and the cathode edge gasket 2112 may prevent the anode flow field plate 2010 and the cathode flow field plate 2008 from breaking while compressing the components of the fuel cell stack 1800 together.

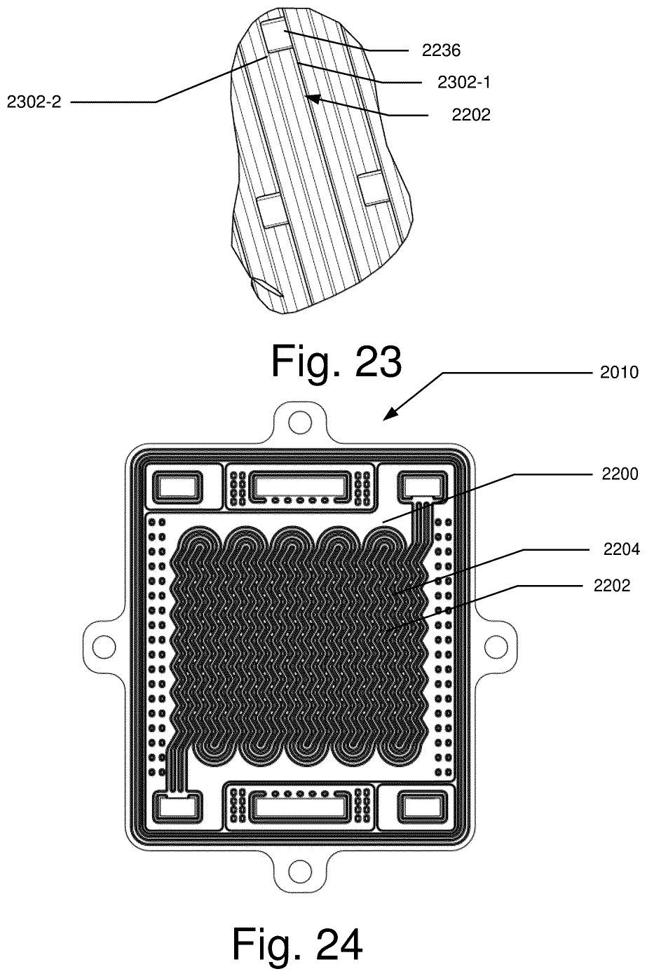

FIG. 22 illustrates a perspective view of the anode flow field plate 2010 of the bipolar plate assembly 2004, in accordance with an implementation of the present subject matter. Here the first anode surface 2200 is shown. As will be understood, the second anode surface 2108 may be behind the first anode surface 2200. The first anode surface 2200 may include the third plurality of ribs, such as 2202-1, 2202-2, 2202-3, and the third plurality of flow channels 2204-1, 2204-2, 2204-3. The third plurality of ribs may be collectively referred to as the third plurality of ribs 2202 and the third plurality of flow channels may be collectively referred to as the third plurality of flow channels 2204. In an example, the third plurality of ribs 2202, the third plurality of flow channels 2204 are of triple serpentine shape. Since the ribs on one surface are complementary to the flow channels on the opposite surface and the flow channels on one surface are complementary to the ribs on the opposite surface, the fourth plurality of ribs and the fourth plurality of flow channels 2110 may be of serpentine shape. Similarly, the first plurality of ribs (not shown in FIG. 22), the first plurality of flow channels 2106 (not shown in FIG. 22) may be of triple serpentine shape. Due to the complementary nature of the ribs and the flow channels, the second plurality of ribs (not shown in FIG. 22) and the second plurality of flow channels may be of triple serpentine shape.

The bipolar plate assembly 2004 may include a first inlet manifold 2206 to provide oxidant and the coolant from the blower 1806 (not shown in FIG. 22) and a second inlet manifold 2208 to provide fuel from the fuel source (not shown in FIG. 22). A first opening (not shown in FIG. 22) of the cathode flow field plate 2008 and a second opening 2210 of the anode flow field plate 2010 may together form the first inlet manifold 2206. A third opening (not shown in FIG. 22) of the cathode flow field plate 2008 and a fourth opening 2212 of the anode flow field plate 2010 may together form the second inlet manifold 2208. In an example, the first inlet manifold 2206 may be coupled to an inlet of the first plurality of flow channels 2106 (not shown in FIG. 20) to provide the oxidant and the second inlet manifold 2208 may be coupled to an inlet of the third plurality of flow channels 2204. In an example, to provide the coolant, the first inlet manifold 2206 may be coupled to an inlet of the second plurality of flow channels (not shown in FIG. 24) and to an inlet of the fourth plurality of flow channels 2110. Further, to remove the excess fuel from the bipolar plate assembly 2004, the bipolar plate assembly 2004 may include the first outlet manifold 2214. Similarly, to remove the excess oxidant and the coolant from the bipolar plate assembly 2004, the bipolar plate assembly 2004 may include the second outlet manifold 2216. A fifth opening (not shown in FIG. 22) of the cathode flow field plate 2008 and a sixth opening 2218 of the anode flow field plate 2010 may together form the first outlet manifold 2214. A seventh opening (not shown in FIG. 22) of the cathode flow field plate 2008 and an eighth opening 2220 of the anode flow field plate 2010 may together form the second outlet manifold 2216.

In some examples, the coolant and the oxidant are provided separately. In such examples, the oxidant may be provided using the first inlet manifold 2206 and the excess oxidant may exit using the first outlet manifold 2214. Further, the bipolar plate assembly 2004 may include a third inlet manifold 2221-1 through which the coolant may be provided to the bipolar plate assembly 2004 and a third outlet manifold 2221-2 through which the excess coolant may exit the bipolar plate assembly 2004.

In an example, the cathode flow field plate 2008 and the anode flow field plate 2010 may be coupled together by welding. For instance, the flow field plates may be welded such that the second anode surface 2108 (not shown in FIG. 22) and the second cathode surface may face each other and may be in contact with each other. The welding may be, for example, spot welding and may be done on the first anode surface 2200. The welding may have to ensure that the coupling of the anode flow field plate 2010 and the cathode flow field plate 2008 is intact, and that there is enough gap for the coolant to flow on the second anode surface 2108 and the second cathode surface. Accordingly, in an example, spot welding may be done adjacent to the edges of the anode flow field plate 2010, such as a first edge 2222 and a second edge 2224, and around the third inlet manifold 2221-1 and the third outlet manifold 2221-2, depicted by the weld spots 2226. The welding spots may prevent the leakage of the coolant from the bipolar plate assembly 2004. Further, the welding spots provided around the third inlet manifold 2221-1 may provide pathway for the coolant entering through the third inlet manifold 2221-1 to flow into the second plurality of flow channels and into the fourth plurality of flow channels 2110. Similarly, the welding spots provided around the third outlet manifold 2221-2 may provide pathway for the excess coolant to exit from the second plurality of flow channels and the fourth plurality of flow channels 2110 through the third outlet manifold 2221-2. The provision of the spot welding may enhance the electrical conductivity of the bipolar plate assembly 2004 during operation. In some examples, to weld the anode flow field plate 2010 and the cathode flow field plate 2008, the welding may be done on the first cathode surface 2104 instead of welding on the first anode surface 2200.

The anode gasket 2012 may be disposed on a first anode groove 2230. In an example, the anode gasket 2012 may be shaped similar to that of the gasket 322. The anode edge gasket 2017 may be disposed on a second anode groove 2232. As will be understood, a liquid sealant may be disposed on the first anode groove 2230 and on the second anode groove 2232 and may be allowed to solidify to form the gaskets. Similar to the anode gasket 2012, the cathode gasket 2014 may be disposed on a first cathode groove (not shown in FIG. 22) on the first cathode surface 2104 (not shown in FIG. 22). The cathode edge gasket 2112 may be disposed on a second cathode groove (not shown in FIG. 22) on the first cathode surface 2104.

The anode flow field plate 2010 may have a plurality of guider holes 2234 to facilitate insertion of guiders, which may facilitate assembly of various components of the fuel cell stack 1800. Similarly, the cathode flow field plate 2008 may have a plurality of guiders holes to facilitate insertion of guiders.

Similar to the bipolar plate assembly 204-1, the bipolar plate assembly 2004 may include bypass channels 2236, which may act as additional pathway for the fuel and prevent the blockage of fuel.

FIG. 23 illustrates an enlarged view of a portion of the view depicted in FIG. 22, in accordance with an implementation of the present subject matter. Here a portion of the first anode surface 2200 is shown. The bypass channel 2236 may be formed between two adjacent ribs that are displaced from each other. For instance, a first rib 2302-1 and a second rib 2302-2 of the third plurality of ribs 2202 are displaced from each other to form the bypass channel 2236.

In some example, the flow channels may be of different pattern to increase the residence time of the fuel and the oxidant to ensure that maximum amount of the fuel and the oxidant reaches the respective gas diffusion layers.

FIG. 24 illustrates the anode flow field plate 2010 of the bipolar plate assembly 2004, in accordance with an implementation of the present subject matter. In an example, in addition to having a triple serpentine shape, each rib of the third plurality of ribs 2202 may have a wave shape. Accordingly, the third plurality of ribs 2202 may be referred to as having a shape of a wavy triple serpentine structure. Since the third plurality of ribs 2202 are of a wavy tripe serpentine shape, the third plurality of flow channels 2204 may have a wavy triple serpentine shape. Similarly, the first plurality of flow channels 2106 (not shown in FIG. 24), the second plurality of flow channels (not shown in FIG. 24), and the fourth plurality of flow channels 2110 (not shown in FIG. 24) may have a wavy triple serpentine shape. The wavy triple serpentine shape may increase the residence time of the fuel, and the oxidant. That is, the wavy triple serpentine shape of the flow channels may increase the time in which fuel and the oxidant is present in the respective flow channels. Accordingly, it gives more time for the fuel and the oxidant to reach the respective gas diffusion layer of the fuel cell before reaching their respective outlet manifold. Such increase in residence time may increase the amount of fuel and the oxidant available for reaction. Therefore, in the present subject matter, the efficiency of the fuel cell stack 1800 is enhanced.

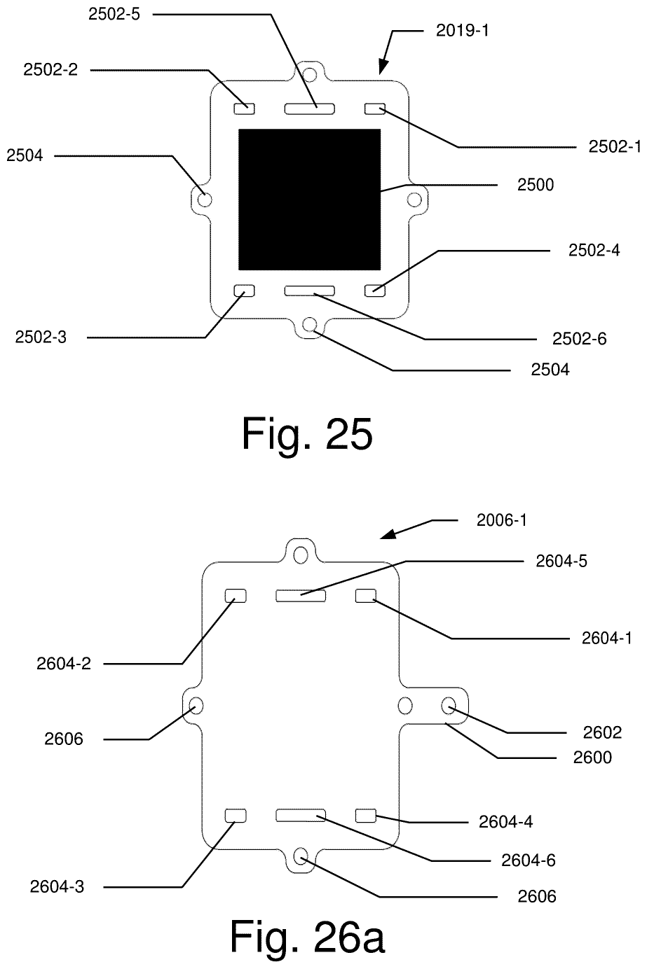

FIG. 25 illustrates the MEA 2019-1 of the fuel cell stack 1800, in accordance with an implementation of the present subject matter. Here, the gas diffusion layer 2500 on the MEA 2019-1 is depicted. As will be understood, the anode may be behind the gas diffusion layer 2500, the PEM may be behind the anode, the cathode may be behind the PEM and the first gas diffusion layer may be behind the cathode. The MEA may include the openings, such as opening 2502-1-2502-6, for entry and removal of the fuel, the oxidant, and the coolant. Further, the MEA 2019-1 may also include a plurality of guider holes 2504. Although in the above example, the MEA is explained with reference to the MEA 2019-1, in some examples, the MEA may be explained with reference to the MEA 2019-2.

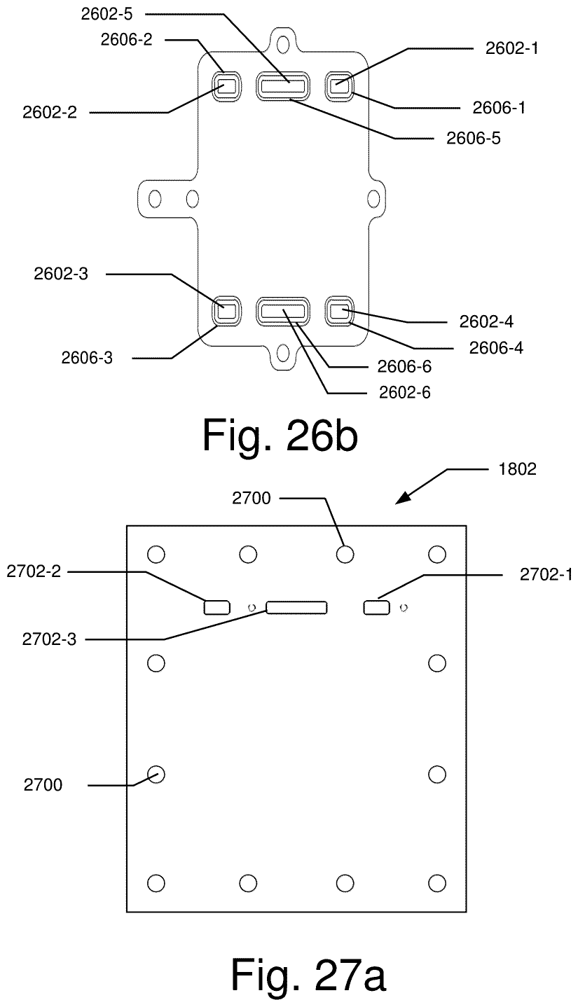

FIG. 26a illustrates a front view of the first current collector plate 2006-1 of the fuel cell stack 1800, in accordance with an implementation of the present subject matter.

Similar to the first current collector plate 112-1, the electrons from the first current collector plate 2006-1 may flow to the second current collector plate 2006-2 (not shown in FIG. 26) through an external circuit, constituting electrical current from the fuel cell stack 1800. In this regard, the first current collector plate 2006-1 may include a provision 2600, which may include an opening 2602 to connect wires to a similar opening (not shown in FIG. 26) in the second current collector plate 2006-2. Further, the first current collector plate 2006-1 may include the openings, such as 2604-1-2604-6, for inlet and the outlet of the fuel, the oxidant and the coolant. The first current collector plate may include a plurality of guider holes 2606.

FIG. 26b illustrates a rear view of the first current collector plate 2006-1 of the fuel cell stack 1800, in accordance with an implementation of the present subject matter. The first current collector plate 2006-1 may include a plurality of gaskets to prevent the leakage of the fuel, the oxidant and the coolant. For instance, a gasket 2606-1 around the opening 2602-1 corresponding to the inlet of the fuel to prevent the leakage of the fuel, a gasket 2606-2 around the opening 2602-2 corresponding to inlet of the oxidant to prevent the leakage of the oxidant, a gasket 2606-3 around the opening 2602-3 corresponding to the outlet of the fuel to prevent the leakage of the fuel, a gasket 2606-4 around the opening 2602-4 corresponding to the outlet of the oxidant to prevent the leakage of the oxidant, a gasket 2606-5 around the opening 2602-5 corresponding to the inlet of the coolant and a gasket 2606-6 around the opening 2602-6 corresponding to the outlet of the coolant to prevent the leakage of the coolant. As will be understood, the second current collector plate 2006-2 may have a similar arrangement as the first current collector plate 2006-1.

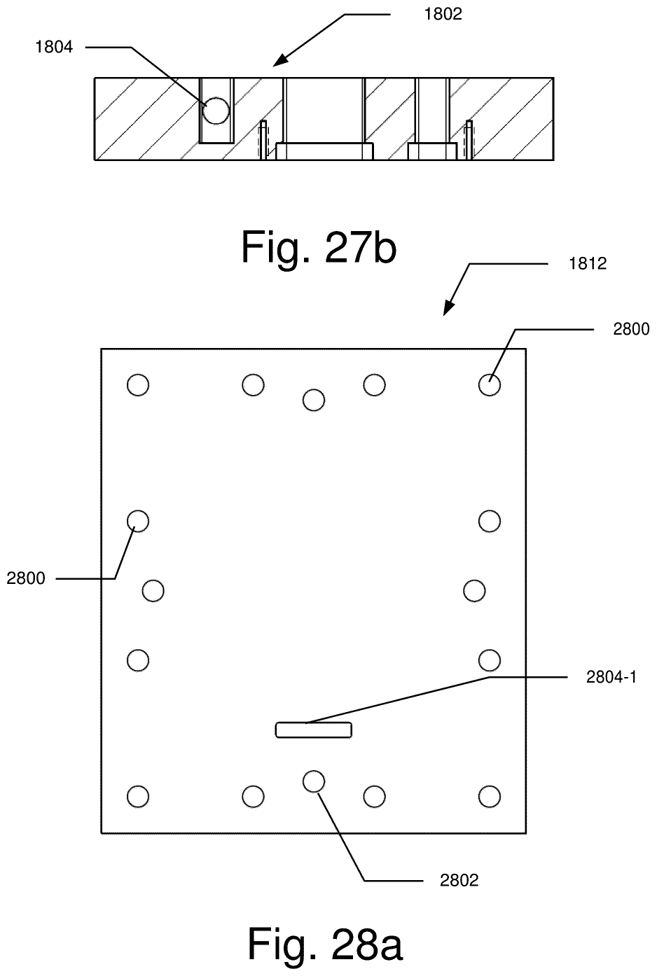

FIG. 27a illustrates a front view of the inlet end plate 1802 of the fuel cell stack 1800, in accordance with an implementation of the present subject matter. The inlet end plate 1802 may include a plurality of openings 2700 for insertion of the tie-rods (not shown in FIG. 27). and openings, such as 2702-1-2702-3, for inlet of the fuel, inlet of the oxidant, and the inlet of the coolant respectively.

FIG. 27b illustrates a sectional view of the inlet end plate 1802 of the fuel cell stack 1800, in accordance with an implementation of the present subject matter. Here, the second inlet 1804 is depicted. Through the second inlet 1804, the hydrogen fuel may be provided to the fuel cell stack 1800.

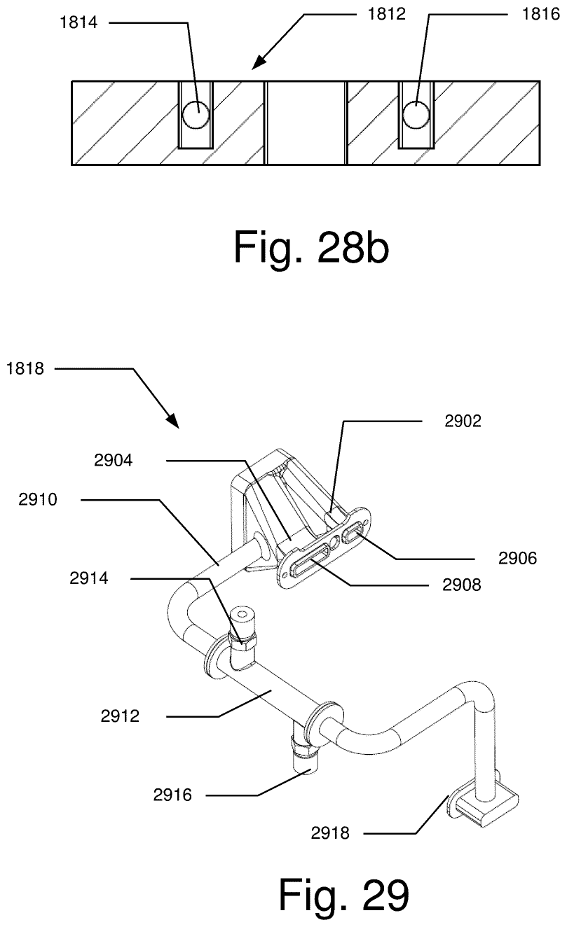

FIG. 28a illustrates a front view of the outlet end plate 1812 of the fuel cell stack 1800, in accordance with an implementation of the present subject matter.

Similar to the inlet end plate 1802, the outlet end plate 1812 may include a plurality of openings 2800 for insertion of the tie-rods (not shown in FIG. 28a), a plurality of guiders holes 2802, for insertion of the guiders (not shown in FIG. 28a) and may include openings, such as opening 2804-1 for outlet of the coolant, an opening (not shown in FIG. 28a) for outlet of the fuel, and an opening (not shown in FIG. 28a) for the outlet of the oxidant.

FIG. 28b illustrates a sectional view of the outlet end plate 1812 of the fuel cell stack 1800, in accordance with an implementation of the present subject matter. Here, the first outlet 1814 and the second outlet 1816 are depicted. Through the first outlet 1814, the excess fuel may exit the fuel cell stack 1800 and through the second outlet 1816, the excess air may exit the fuel cell stack 1800. In an example, the excess air exiting the fuel cell stack 1800 may be recirculated inside the fuel cell stack 1800 as the coolant through the recirculation unit 1818.

FIG. 29 illustrates the recirculation unit 1818 of the fuel cell stack 1800, in accordance with an implementation of the present subject matter. The recirculation unit 1818 may receive the excess oxidant and the excess coolant from the fuel cell stack 1800. To receive the excess oxidant and the coolant, the recirculation unit 1818 may include an oxidant inlet duct 2902 coupled to the first outlet 1814 and a coolant inlet duct 2904 coupled to the third outlet (not shown in FIG. 29). The excess oxidant of the fuel cell stack 1800 may enter the oxidant inlet duct 2902 through a first inlet 2906 and the excess coolant of the fuel cell stack 1800 may enter the coolant inlet duct 2904 through a second inlet 2908. Accordingly, the oxidant air and the coolant air may mix together in the duct 2910 of the recirculation unit 1818. Further, the temperature of the coolant air and the oxidant air may be higher than the optimum temperature due to the increase of temperature in the fuel cell stack 1800. In this regard, to reduce the temperature of the air in the recirculation unit 1818, the recirculation unit 1818 may include a heat exchanger 2912. The heat exchanger 2912 may cool the air flowing through it. In an example, to reduce the temperature of the air flowing through the heat exchanger 2912, a coolant may flow through the heat exchanger 2912. As will be understood, the coolant flowing the heat exchanger may take away the heat energy from the air flowing through the heat exchanger 2912 and may bring down the temperature of the air. To facilitate circulation of coolant through the heat exchanger 2912, the heat exchanger may include a heat exchanger coolant inlet 2914 to facilitate entry of the coolant into the heat exchanger 2912 and a heat exchanger coolant outlet 2916 to facilitate removal of the coolant from the heat exchanger 2912.

Further, upon flowing through the heat exchanger 2912, the air may exit the recirculation unit 1818 through a coolant outlet 2918. The coolant outlet 2918 may be coupled to the second duct 1902 (not shown in FIG. 29), such that the recirculated air may flow as the coolant into the fuel cell stack 1800 again. By the use of recirculation unit 1818, the amount of coolant to be circulated inside the fuel cell stack 1800 may be increased without having to increase the power of the blower 1806 that is to provide the coolant.

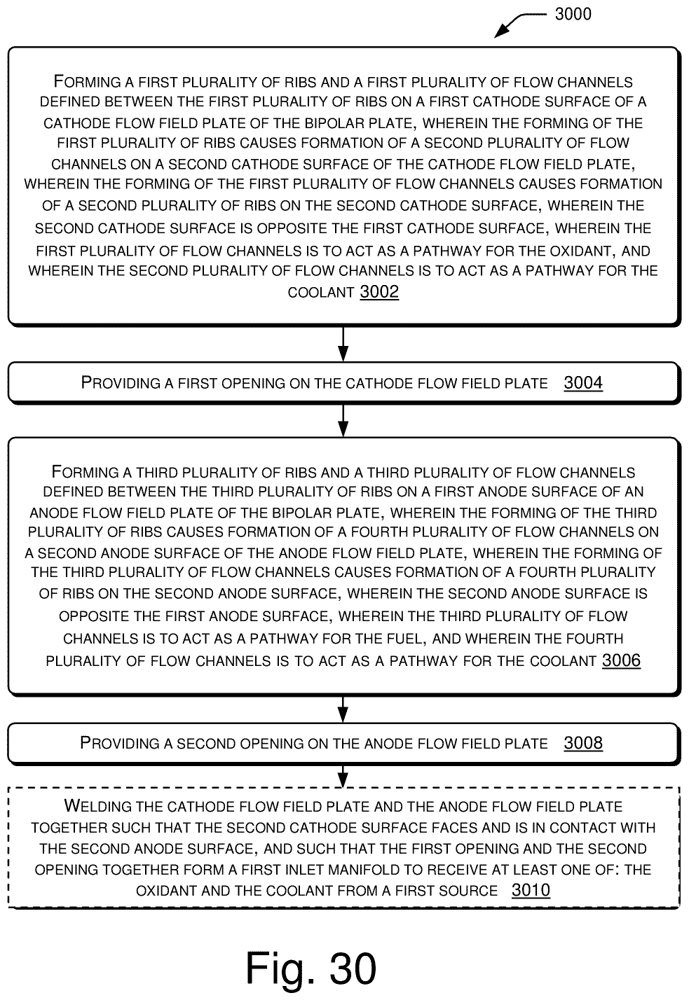

FIG. 30 illustrates a method 3000 for manufacturing a bipolar plate assembly for fuel cell stack, in accordance with an implementation of the present subject matter. The order in which the method blocks are described is not included to be construed as a limitation, and some of the described method blocks can be combined in any order to implement the method 3000, or an alternative method. Additionally, some of the individual blocks may be deleted from the method 3000 without departing from the scope of the subject matter described herein.

At block 3002, a first plurality of ribs and a first plurality of flow channels defined between the first plurality of ribs may be formed on a first cathode surface of a cathode flow field plate of the bipolar plate assembly. The forming of the first plurality of ribs may cause formation of a second plurality of flow channels on a second cathode surface of the cathode flow field plate and the forming of the first plurality of flow channels may cause formation of a second plurality of ribs on the second cathode surface. The second cathode surface may be opposite the first cathode surface. The first plurality of flow channels may act as a pathway for the oxidant and the second plurality of flow channels may act as a pathway for the coolant. The bipolar plate assembly may correspond to the bipolar plate assembly 204-1 or the bipolar plate assembly 2004. The cathode flow field plate may correspond to the cathode flow field plate 306 or the cathode flow field plate 2008. The first plurality of ribs may correspond to the first plurality of ribs 500. The first plurality of flow channels may correspond to the first plurality of flow channels 502 or the first plurality of flow channels 2106. The second plurality of ribs may correspond to the second plurality of ribs 404. The second plurality of flow channels may correspond to the second plurality of flow channels 406.

At block 3004, a first opening on the cathode flow field plate may be provided. The first opening may correspond to the first opening 422. At block 3006, a third plurality of ribs and a third plurality of flow channels defined between the third plurality of ribs may be formed on a first anode surface of an anode flow field plate of the bipolar plate assembly. The forming of the third plurality of ribs may cause formation of a fourth plurality of flow channels on a second anode surface of the anode flow field plate. The forming of the third plurality of flow channels may cause formation of a fourth plurality of ribs on the second anode surface. The second anode surface may be opposite the first anode surface. The third plurality of flow channels may act as a pathway for the fuel, and the fourth plurality of flow channels may act as a pathway for the coolant. The anode flow field plate may correspond to the anode flow field plate 308 or the anode flow field plate 2010. The third plurality of ribs may correspond to the third plurality of ribs 410 or the third plurality of ribs 2202. The third plurality of flow channels may correspond to the third plurality of flow channels 412 or the third plurality of flow channels 2204. The fourth plurality of ribs may correspond to the fourth plurality of ribs 612. The fourth plurality of flow channels may correspond to the fourth plurality of flow channels 614 or the fourth plurality of flow channels 2110. At block 3008, a second opening may be provided on the anode flow field plate. The second opening may correspond to the second opening 424 or the second opening 2210.

At block 3010, the cathode flow field plate and the anode flow field plate may be welded together such that the second cathode surface faces and is in contact with the second anode surface, and such that the first opening and the second opening together form a first inlet manifold to receive the oxidant, the coolant, or both from a first source.

The method 3000 may further include providing a first cathode groove on the first cathode surface and a first anode groove on the first anode surface. The first anode groove may correspond to the first anode groove 444 or the first anode groove 2230. The first cathode groove may correspond to the first cathode groove 510. Further, the cathode flow field and the anode flow field plate may be welded together by welding on the first cathode groove. The welding may form a weld seam on the first cathode groove. Furthermore, a cathode gasket of the bipolar plate assembly may be provided on top of the weld seam to prevent the leakage of the oxidant and an anode gasket of the bipolar plate assembly may be provided on the first anode groove to prevent the leakage of the fuel. The anode gasket may correspond to the anode gasket 322 or the anode gasket 2012 and the cathode gasket may correspond to the cathode gasket 324 or the cathode gasket 2014.

In the above examples, the welding is done on the first cathode surface. However, in some example, the welding may be done on the first anode surface. In such examples, the method 3000 may include providing the first anode groove on the first anode surface and the first cathode groove on the first cathode surface. Further, the cathode flow field plate and the anode flow field plate may be welded together by welding on the first anode groove. The welding may form a weld seam on the first anode groove. Furthermore, in such examples, the anode gasket may be provided on top of the weld seam to prevent the leakage of the fuel and the cathode gasket may be provided on the first cathode groove to prevent the leakage of the oxidant.

The present subject matter eliminates the use of separate coolant flow field plate by having coolant flow channels on the cathode flow field plate and on the anode flow field plate. Therefore, the size of the fuel cell stack is reduced. Further, by having such an arrangement of the coolant flow channels, the present subject matter ensures uniform cooling across the fuel cell stack. Therefore, the present subject matter enhances the performance of the fuel cells. Also, since the thickness of the bipolar plate assembly is less, the present subject matter reduces the weight of the fuel cell stack and facilitates easy assembly of the components of the fuel cell stack. With the implementation of the present subject matter, a common manifold can be used for oxidant and the coolant. Accordingly, the present subject matter prevents use of additional components, such as separate ducts for oxidant and coolant respectively, and reduces the cost of manufacturing of the fuel cell stack.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

1.-20. (canceled)

21. A bipolar plate assembly for a fuel cell stack comprising:
a cathode flow field plate comprising:
a first cathode surface having a first plurality of ribs and a first plurality of flow channels defined between the first plurality of ribs to act as a pathway for an oxidant for a first fuel cell of the fuel cell stack; and
a second cathode surface opposite the first cathode surface having a second plurality of ribs and a second plurality of flow channels defined between the second plurality of ribs to act as a pathway for a coolant, wherein the second plurality of flow channels is complementary to the first plurality of ribs and the second plurality of ribs is complementary to the first plurality of flow channels;
an anode flow field plate comprising:
a first anode surface comprising a third plurality of ribs and a third plurality of flow channels defined between the third plurality of ribs to act as a pathway for a fuel for a second fuel cell of the fuel cell stack, wherein a bypass channel is defined between adjacent ribs from among the third plurality of ribs to act as an additional pathway for the fuel; and
a second anode surface opposite the first anode surface having a fourth plurality of ribs and a fourth plurality of flow channels defined between the fourth plurality of ribs to act as the pathway for the coolant, wherein the fourth plurality of flow channels is complementary to the third plurality of ribs and the fourth plurality of ribs is complementary to the third plurality of flow channels, wherein the second anode surface faces and is in contact with the second cathode surface;
a first inlet manifold to receive at least one of: the oxidant and the coolant from a first source, being provided on provided on the cathode flow field plate; and
a second inlet manifold to receive the fuel from a second source, being provided on the anode flow field plate.

22. The bipolar plate assembly as claimed in claim 21, wherein the first inlet manifold is connected to an inlet of the first plurality of flow channels and to an inlet of the second plurality of flow channels.

23. The bipolar plate assembly as claimed in claim 21, wherein the first inlet manifold is connected to an inlet of the first plurality of flow channels to receive the oxidant, and wherein the bipolar plate assembly comprises:
a third inlet manifold is connected to an inlet of the second plurality of flow channels to receive the coolant.

24. The bipolar plate assembly as claimed in claim 21, comprising:
a weld seam formed on a first cathode groove of the first cathode surface by welding of the anode flow field plate with the cathode flow field plate;
a cathode gasket on the weld seam to prevent leakage of the oxidant; and
an anode gasket on a first anode groove of the first anode surface to prevent leakage of the fuel.

25. The bipolar plate assembly as claimed in claim 21, comprising:
a weld seam formed on a first anode groove of the first anode surface by welding of the anode flow field plate with the cathode flow field plate;
an anode gasket on the weld seam to prevent leakage of the fuel; and
a cathode gasket on a first cathode groove of the first cathode surface to prevent leakage of the oxidant.

26. The bipolar plate assembly as claimed in claim 21, wherein
the first inlet manifold is formed by a first opening on the cathode flow field plate and a second opening on the anode flow field plate,
the second inlet manifold is formed by a third opening on the cathode flow field plate and a fourth opening on the anode flow field plate,
the first opening and the third opening are displaced perpendicular to each other relative to a centre of the cathode flow field plate, and
the second opening and the fourth opening are displaced perpendicular to each other relative to a centre of the anode flow field plate.

27. The bipolar plate assembly as claimed in claim 21, comprising:
a first outlet manifold to remove the oxidant and the coolant, wherein each of the third plurality of flow channels and each of the fourth plurality of flow channels are of a serpentine pattern, wherein the first plurality of flow channels and the second plurality of flow channels are parallel to each other and extend from the first inlet manifold to the first outlet manifold.

28. The bipolar plate assembly as claimed in claim 21, wherein the anode flow field plate and the cathode flow field plate are made of a metal.

29. The bipolar plate assembly as claimed in claim 21, wherein the second inlet manifold is provided on the cathode flow field plate and the anode flow field plate, wherein:
the second anode surface comprises an anode flat section nearer to the second inlet manifold than a centre of the anode flow field plate,
the second cathode surface comprises a cathode flat section nearer to the second inlet manifold than a centre of the cathode flow field plate,
the anode flow field plate and the cathode flow field plate are welded such that the anode flat section faces and is in contact with the cathode flat section to prevent the flow of the fuel on the second anode surface.

30. The bipolar plate assembly as claimed in claim 21, wherein:
the third plurality of ribs comprises:
a third rib extending from the second inlet manifold and having a discontinuity nearer to the second inlet manifold than a centre of the anode flow field plate; and
the fourth plurality of flow channels comprises:
a first flow channel extending from the second inlet manifold and having a discontinuity nearer to the second inlet manifold than the centre of the anode flow field plate, the first flow channel being complementary to the third rib, wherein the discontinuity of the first flow channel is to prevent the fuel flow on the second anode surface.

31. A fuel cell stack comprising:
a first fuel cell;
a second fuel cell;
a bipolar plate assembly between the first fuel cell and the second fuel cell, the bipolar plate assembly comprising:
a cathode flow field plate comprising:
a first cathode surface having a first plurality of ribs and a first plurality of flow channels defined between the first plurality of ribs to act as a pathway for an oxidant for the first fuel cell; and
a second cathode surface opposite the first cathode surface having a second plurality of ribs and a second plurality of flow channels defined between the second plurality of ribs to act as a pathway for a coolant, wherein the second plurality of flow channels is complementary to the first plurality of ribs and the second plurality of ribs is complementary to the first plurality of flow channels; and
an anode flow field plate comprising:
a first anode surface comprising a third plurality of ribs and a third plurality of flow channels defined between the third plurality of ribs to act as a pathway for a fuel for a second fuel cell of the fuel cell stack, wherein a bypass channel is defined between adjacent ribs of the third plurality of ribs to act as an additional pathway for the fuel; and
a second anode surface opposite the first anode surface having a fourth plurality of ribs and a fourth plurality of flow channels defined between the fourth plurality of ribs to act as the pathway for the coolant, wherein the fourth plurality of flow channels is complementary to the third plurality of ribs and the fourth plurality of ribs is complementary to the third plurality of flow channels, wherein second cathode surface faces and is in contact with the second anode surface;
a first inlet manifold to receive at least one of: the oxidant and the coolant from a blower; and
a second inlet manifold to receive the fuel from a fuel source;
the blower to supply the oxidant and the coolant; and
the fuel source.

32. The fuel cell stack as claimed in claim 31, wherein the first inlet manifold is to receive both the oxidant and the coolant, wherein the first inlet manifold is connected to an inlet of the first plurality of flow channels and to an inlet of the second plurality of flow channels, the fuel cell stack comprising:
a first duct coupled to the blower on one end and to the first inlet manifold on another end, to provide the oxidant and the coolant to the fuel cell stack.

33. A fuel cell system comprising:
a fuel cell stack comprising:
a first fuel cell;
a second fuel cell;
a bipolar plate assembly between the first fuel cell and the second fuel cell, the bipolar plate assembly comprising:
a cathode flow field plate comprising:
a first cathode surface having a first plurality of ribs and a first plurality of flow channels defined between the first plurality of ribs; and
a second cathode surface opposite the first cathode surface having a second plurality of ribs and a second plurality of flow channels defined between the second plurality of ribs, wherein the second plurality of flow channels is complementary to the first plurality of ribs and the second plurality of ribs is complementary to the first plurality of flow channels; and
an anode flow field plate comprising:
a first anode surface comprising a third plurality of ribs and a third plurality of flow channels defined between the third plurality of ribs to act as a pathway for a fuel for a second fuel cell of the fuel cell stack, wherein a bypass channel is defined between adjacent ribs of the third plurality of ribs to act as an additional pathway for the fuel; and
a second anode surface opposite the first anode surface having a fourth plurality of ribs and a fourth plurality of flow channels defined between the fourth plurality of ribs to act as the pathway for a coolant, wherein the fourth plurality of flow channels is complementary to the third plurality of ribs and the fourth plurality of ribs is complementary to the third plurality of flow channels, wherein second cathode surface faces and is in contact with the second anode surface; and
a casing to enclose the fuel cell stack.

34. The fuel cell system as claimed in claim 33, the fuel cell system comprising:
a hydrogen sensor provided within the casing to detect hydrogen leak in the fuel cell stack; and
a pressure relief valve disposed in the casing to avoid explosion due to pressure build up in the casing.

35. A method for manufacturing a bipolar plate assembly, the method comprises:
forming a first plurality of ribs and a first plurality of flow channels defined between the first plurality of ribs on a first cathode surface of a cathode flow field plate of the bipolar plate assembly, wherein the forming of the first plurality of ribs causes formation of a second plurality of flow channels on a second cathode surface of the cathode flow field plate, wherein the forming of the first plurality of flow channels causes formation of a second plurality of ribs on the second cathode surface, wherein the second cathode surface is opposite the first cathode surface, wherein the first plurality of flow channels is to act as a pathway for a oxidant, and wherein the second plurality of flow channels is to act as a pathway for a coolant;
providing a first opening on the cathode flow field plate;
forming a third plurality of ribs and a third plurality of flow channels defined between the third plurality of ribs on a first anode surface of an anode flow field plate of the bipolar plate assembly, wherein the forming of the third plurality of ribs causes formation of a fourth plurality of flow channels on a second anode surface of the anode flow field plate, wherein the forming of the third plurality of flow channels causes formation of a fourth plurality of ribs on the second anode surface, wherein the second anode surface is opposite the first anode surface, wherein the third plurality of flow channels is to act as a pathway for a fuel, wherein a bypass channel is defined between adjacent ribs of the third plurality of ribs to act as an additional pathway for a fuel and wherein the fourth plurality of flow channels is to act as a pathway for the coolant;
providing a second opening on the anode flow field plate; and
welding the cathode flow field plate and the anode flow field plate together such that the second cathode surface faces and is in contact with the second anode surface, and such that the first opening and the second opening together form a first inlet manifold to receive at least one of: the oxidant and the coolant from a first source.

36. The method as claimed in claim 35, comprising:
welding the cathode flow field plate and the anode flow field plate together by one of: continuous welding or spot welding on the first cathode surface.

37. The method as claimed in claim 35, comprising:
welding the cathode flow field plate and the anode flow field plate together by one of: spot welding or continuous welding on the first anode surface.

38. The method as claimed in claim 35, comprising:
providing a first cathode groove on the first cathode surface and a first anode groove on the first anode surface;
welding the cathode flow field plate and the anode flow field plate together by welding on the first cathode groove, wherein the welding forms a weld seam on the first cathode groove; and
providing a cathode gasket of the bipolar plate assembly on top of the weld seam to prevent leakage of the oxidant and an anode gasket of the bipolar plate assembly on the first anode groove to prevent leakage of the fuel.

39. The method as claimed in claim 35, comprising:
providing a first anode groove on the first anode surface and a first cathode groove on the first cathode surface;
welding the cathode flow field plate and the anode flow field plate together by welding on the first anode groove, wherein the welding forms a weld seam on the first anode groove; and
providing an anode gasket of the bipolar plate assembly on top of the weld seam to prevent leakage of the fuel and a cathode gasket of the bipolar plate assembly on the first cathode groove to prevent leakage of the oxidant.
